(19) United States
(12) Patent Application Publication
(10) Pub. No.: US 2026/0024941 A1
(43) Pub. Date: Jan. 22, 2026

(54) ROBUST CONNECTOR PROTECTION APPARATUS

(71) Applicant: FCI OEN connectors Limited, Kochi (IN)

(72) Inventors: Alex Babu Thuruthummalil, Kochi (IN); Binesh Chandresan, Kochi (IN); Sivasankar Thundiyil Sathyapalan, Kochi (IN)

(73) Assignee: FCI OEN connectors Limited, Kochi (IN)

(21) Appl. No.: 19/340,479

(22) Filed: Sep. 25, 2025

Related U.S. Application Data
(63) Continuation of application No. PCT/IN2024/050322, filed on Mar. 27, 2024.

(30) Foreign Application Priority Data
Mar. 27, 2023 (IN) 202341021801

(51) Int. Cl. H01R 13/52; G02B 6/38

(52) U.S. Cl. CPC H01R 13/5219; H01R 13/5213; G02B 6/3849

(57) ABSTRACT

Components to protect an electronic assembly from moisture and other contaminants. These components may include a protector that receives a connector terminating a cable routed to the electronic assembly. The protector may securely engage the electronic assembly to form an environmental seal with an enclosure for the electronic assembly. That seal may be retained despite large and/or impulsive forces on the cable, even in a sideways direction. Stabilizers providing resistance to such forces may include a cross bar, joining two latching arms on opposing sides of the protector and/or lips on the protector housing that engage features of a bulkhead of the electronic assembly to counter sideways force. A locking mechanism may be automatically engaged once the protector is latched to the subassembly. Protective components may also include a cap that is securely retained and includes an audible indication when it is latched to the electronic assembly.

### TECHNICAL FIELD

This patent application relates generally to interconnection systems and more particularly to protectors for connectors.

### BACKGROUND

Electrical connectors are used in many electronic systems. An electronic assembly may be manufactured with one or more connectors that have a mating interface to which a connector, coupled to other subassemblies, may be connected and disconnected. When connectors are mated, they complete conducting paths between the subassemblies, enabling the subassemblies to exchange data signals and/or power with each other.

If two subassemblies are close together, connectors on the two subassemblies may be mated directly to each other. In other instances, subassemblies to be connected are spaced apart, and cables may be used to route data signals and/or power between the subassemblies. Cables may contain wires, which can carry electrical signals, or may contain optical fibers, which may carry data signals as modulated light. When connections are made through cables, either or both ends of a cable may be terminated with a connector that is mated with a connector in one of the subassemblies to be connected.

In some electronic systems, a subassembly may be inside an enclosure. Enclosures may be used for any number of reasons, such as to protect the subassembly from physical damage as a result of contact, prevent injury to a person from accidental contact with the electronic components, suppress electromagnetic interference emanating from or impinging on the electronic subassembly, or protect the subassembly from environmental damage. Connections may be made through openings in a panel of the enclosure. A board connector, often configured as a receptacle connector, may be mounted on a PCB inside the enclosure next to an opening in the panel. A second connector, which is often a plug connector terminating a cable, may be inserted through the opening in the panel to mate with the receptacle connector on the PCB inside the enclosure.

Some electronic systems may have subassemblies in settings prone to environmental conditions that could interfere with operation of the system. For example, in an outdoor setting, dust, dirt, or moisture may interfere with operation of the system after penetrating an enclosure. Openings in a panel of the enclosure through which connections are made to a subassembly inside the enclosure enable these contaminants to penetrate the enclosure.

In such settings, water resistant, dust resistant, and/or dirt resistant protectors have been employed. Such protectors may have an outer housing that connects to a bulkhead mounted to or formed as part of the panel around an opening. One or more connectors may be inside an outer housing of the protector such that, when the protector is mounted to the bulkhead, the connector may enter the enclosure through the opening, but the outer housing of the protector forms a seal around the bulkhead that blocks water, dust, and/or dirt from entering the electronic system and interfering with system performance.

Such an architecture is used, for example, in cellular communications systems. A subassembly, such as a transmitter or receiver, may be near an antenna, which is usually outdoors. An enclosure provides protection against harsh weather for the transmitter or receiver. Optical fiber or copper cables may be routed to the subassembly. Those cables may be terminated with transceivers with mating interfaces that serve as plug connectors. Such a plug connector may be enclosed in a protector that can be attached to a bulkhead formed with or mounted to the enclosure. An example of a protector used for this purpose is sold under the name OCTIS by the Applicant.

### BRIEF SUMMARY

Aspects of the present disclosure relate to components that protect an electronic assembly from moisture and other contaminants. According to some aspects, these components may include a protector that receives a connector terminating a cable routed to the electronic assembly. According to some aspects, the protector may securely engage the electronic assembly to form an environmental seal with an enclosure for the electronic assembly, and the seal may be retained despite large and/or impulsive forces on the cable, even in a sideways direction. According to some aspects, a stabilizer providing resistance to such forces may include a cross barjoining two latching arms on opposing sides of the protector. According to some aspects, lips on the protector housing may engage features of a bulkhead of the electronic assembly to counter sideways force. According to some aspects, a locking mechanism may be automatically engaged once the protector is latched to the subassembly. According to some aspects, protective components may also include a cap that is securely retained and includes an audible indication when it is latched to the electronic assembly.

Some aspects of the present disclosure relate to a protector for an electrical and/or optical connector. In some embodiments, the protector may comprise a housing configured to receive a portion of a cable and a connector for connecting the cable to an electronic component, a latch rotatably coupled to the housing, wherein the latch is rotatable with respect to the housing about a first axis to lock and unlock the housing to and from an electronic component, and a stabilizer configured to resist forces on the protector in a first direction parallel to the first axis.

In some embodiments, the latch may comprise a first arm on a first side of the housing along the first direction and a second arm on a second side of the housing along the first direction and the stabilizer may comprise a member of the latch coupling the first arm to the second arm.

In some embodiments, the member may connect the first arm to the second arm on a third side of the housing that connects the first and second sides of the housing.

In some embodiments, the housing may comprise a first opening configured to receive the cable terminated to a connector and a second opening configured to expose a mating interface of the connector when disposed at least in part within the housing, the first arm may comprise a first hook on a first side of the second opening, the second arm may comprise a second hook on a second side of the second opening, and the member may be on a third side of the opening.

In some embodiments, the stabilizer may be further configured to limit rotation of the latch about a second axis that is perpendicular to the first axis.

In some embodiments, the member may be configured to abut the electronic component when the latch locks the housing to the electronic component.

In some embodiments, the latch may be rotatable with respect to the housing in a first rotational direction about the first axis to a locked position and in a second rotational direction about the first axis to an unlocked position and the member may be configured to engage the electronic component when the latch is rotated to the locked position and to disengage the electronic component when the latch is rotated to the unlocked position.

In some embodiments, the member may be configured to distribute force applied to one of the first and second arms to the other of the first and second arms to limit movement of the latch in the first direction.

In some embodiments, the stabilizer may be configured to limit movement of the latch in response to an applied force of 150 N for at least 180 seconds.

In some embodiments, the stabilizer may be configured to limit movement of the latch in response to applied force of 100 Newtons (N).

Some aspects of the present disclosure relate to a protector for an electrical and/or optical connector. In some embodiments, the support may comprise a housing configured to receive a portion of a cable and at least a portion of a connector and a latch, comprising a first arm rotatably coupled to a first side of the housing, a second arm rotatably coupled to a second side of the housing, a handle connecting the first and second arms on a third side of the housing, and a member connecting the first and second arms on a fourth side of the housing.

In some embodiments, the first side of the housing may be opposite the second side of the housing in a first direction and the member may be at least partially elongated in the first direction.

In some embodiments, the member may comprise a first segment elongated in the first direction on the fourth side of the housing, a second segment connecting the first segment to the first arm, and a third segment connecting the first segment to the second arm.

In some embodiments, the housing may comprise a substantially rectangular portion comprising the first, second, third, and fourth sides, and the member may be disposed on at least portions of three of the first, second, third, and fourth sides.

In some embodiments, the first and second sides may be substantially parallel to one another and the third and fourth sides may be substantially parallel to one another.

In some embodiments, the first arm and second arms may comprise rotational coupling members, and the handle may be positioned at an opposite end of the latch from the rotational coupling members.

In some embodiments, the member may be closer to the housing when the latch is in the locked position than when the latch is in the unlocked position.

In some embodiments, the latch may be rotatable with respect to the housing in a first rotational direction about a first axis to the locked position and in a second rotational direction about the first axis to the unlocked position and the member may be configured to limit rotation of the latch in the first rotational direction about the first axis.

In some embodiments, the housing may comprise a first opening configured to expose at least one first electrical and/or optical mating interface of the connector.

In some embodiments, the housing may further comprise a second opening configured to receive the cable.

In some embodiments, the first axis may be closer to the second opening than to the first opening.

In some embodiments, the member may be closer to the first axis than to the first opening.

In some embodiments, the member may be closer to the second end of the housing than to the first end of the housing.

Some aspects of the present disclosure relate to an electrical interconnection system. In some embodiments, the system may comprise a protector for a connector comprising a first housing comprising a first engagement interface and a seal proximate the first engagement interface and an electronic component comprising a second housing supporting a second engagement interface and comprising a cavity proximate the second engagement interface. In some embodiments, the first housing and the second housing may be configured to at least partially compress the seal therebetween and to limit movement of the second housing with respect to the first housing when the first housing engages the second housing.

In some embodiments, the first and second engagement interfaces may be configured to engage one another when moved together in an engagement direction and the first housing may be configured to press against the second housing when the first housing is engaged to the second housing and moved in a plane normal to the mating direction.

In some embodiments, the first housing may comprise exterior surfaces configured to engage respective interior surfaces of the second housing when the first housing is engaged to the second housing and moved in the plane normal to the engagement direction.

In some embodiments, the first housing may comprise a first portion extending beyond the seal in a second direction perpendicular to the engagement direction and the first portion comprises the exterior surfaces.

In some embodiments, the second housing may comprise a cavity and a groove proximate the cavity, the groove comprising the interior surfaces.

In some embodiments, the first housing may comprise a first lip protruding in a first direction perpendicular to the engagement direction and a second lip proximate the engagement interface and protruding in a second direction perpendicular to the engagement direction and different from the first direction, and the first and second lips may be configured to engage the second housing to limit movement of the housing in the plane normal to the engagement direction.

In some embodiments, the second direction may be opposite the first direction.

In some embodiments, the first housing may comprise a first portion having a first wall on a first side of the engagement interface and a second wall on a second side of the engagement interface, the first portion having a first width perpendicular to the engagement direction from the first wall to the second wall, and the first lip may comprise a portion having a second width perpendicular to the engagement direction that is narrower than the first width.

In some embodiments, the portion of the first lip may comprise a first surface normal to a direction of the first and second widths and a second surface normal to the direction of the first and second widths, the second surface may be spaced from the first surface by the second width, and the first and second surfaces of the portion of the first lip may be configured to engage respective interior surfaces of the second housing proximate the cavity when the first housing is engaged to the second housing and moved in the plane normal to the engagement direction.

In some embodiments, the first surface of the portion of the first lip may be configured to, when the first housing is engaged to the second housing and moved in a third direction in the plane normal to the mating direction, press against a first interior surface of the second housing proximate the cavity, and the second surface of the portion of the first lip may be configured to, when the first housing is engaged to the second housing and moved in a fourth direction in the plane normal to the engagement direction and opposite the third direction, press against a second interior surface of the second housing proximate the cavity.

In some embodiments, the first housing may comprise a first body configured to at least partially compress the seal between the first body and the second housing when the first housing engages the second housing, and the first and second lips may be configured to press against the second housing when the first housing is rotated about an axis perpendicular to the engagement direction and to the first direction.

In some embodiments, the first and second lips may be further configured to enclose the seal between the first and second lips and the second housing when the first housing is rotated about the axis.

In some embodiments, the second housing may comprise a first portion configured to enclose the seal between the first lip and the first portion when the first housing is rotated about the axis away from the first portion, and a second portion configured to enclose the seal between the second lip and the second portion when the first housing is rotated about the axis away from the second portion.

In some embodiments, the first portion may be spaced from the second portion in the first direction and the first and second portions protrude from the second housing in the engagement direction.

In some embodiments, the connector may further comprise a latch rotatably coupled to a first side of the first housing and to a second side of the first housing that is opposite the first side in a fourth direction perpendicular to the first and second directions, the latch being configured to lock the first housing to the electronic component.

In some embodiments, the connector may further comprise a latch that is rotatable with respect to the first housing to lock the connector to the electronic component.

In some embodiments, the latch may be rotatable in a first rotational direction toward a locked position to pull the first housing toward the second housing and in a second rotational direction toward an unlocked position to unlock the first housing from the second housing.

In some embodiments, the latch may comprise a first arm rotatably coupled to a first side of the first housing and configured to engage a first side of the second housing and a second arm rotatably coupled to a second side of the first housing and configured to engage a second side of the second housing.

Some aspects of the present disclosure relate to a protector for a connector configured to engage an electronic component. In some embodiments, the protector may comprise a housing comprising a body configured to enclose, at least in part, a connector, the body comprising an opening oriented along a mating direction of the connector to expose a mating interface of the connector to enable the connector to mate with a mating connector of the electronic component, and a first lip proximate the opening and configured to engage the electronic component to limit motion of the housing in a plane normal to the mating direction. In some embodiments, the protector may further comprise a seal, wherein the body is configured to compress the seal between the body and the electronic component when the housing is engaged to the electronic component.

In some embodiments, the first lip may comprise exterior surfaces configured to engage respective interior surfaces of the electronic component when the housing is engaged to the electronic component and moved in the plane normal to the mating direction.

In some embodiments, the first lip may protrude from the body in a first direction perpendicular to the mating direction and the housing may further comprise a second lip proximate the opening and protruding from the housing in a second direction perpendicular to the mating direction and different from the first direction, the second lip being configured to engage the electronic component to limit rotation of the housing in the plane normal to the mating direction.

In some embodiments, the second direction may be opposite the first direction.

In some embodiments, the first and second lips may be further configured to limit rotation of the housing about an axis perpendicular to the mating direction and to the first direction.

In some embodiments, the first and second lips may be further configured to enclose the seal between the first and second lips and the electronic component when the housing is rotated about the axis.

In some embodiments, the housing may comprise a first portion comprising the opening and having a first width perpendicular to the mating direction and the first lip may comprise a portion having a second width perpendicular to the mating direction that is narrower than the first width.

In some embodiments, the protector may further comprise a latch that is rotatable with respect to the housing about a second axis to lock and unlock the housing to and from the electronic component, wherein the first portion of the housing comprises a first wall and a second wall spaced from the first wall by the first width, and arms of the latch are rotatably coupled to the first and second walls, respectively.

In some embodiments, the portion of the first lip may comprise a first surface normal to a direction of the first and second widths and a second surface normal to the direction of the first and second widths, the second surface may be spaced from the first surface by the second width, and the first and second surfaces of the portion of the first lip may be configured to engage respective interior surfaces of the electronic component when the housing is engaged to the electronic component and moved in the plane normal to the mating direction.

In some embodiments, the first surface of the portion of the first lip may be configured to, when the housing is engaged to the electronic component and moved in a third direction in the plane normal to the mating direction, press against a first interior surface of the electronic component, and the second surface of the portion of the first lip may be configured to, when the housing is engaged to the electronic component and moved in a fourth direction in the plane normal to the mating direction and opposite the third direction, press against a second interior surface of the electronic component.

In some embodiments, the opening may be positioned at a first end of the housing, and the housing further comprises a second opening configured to receive a cable at a second end of the housing.

Some aspects of the present disclosure relate to a protector for an electrical and/or optical connector. In some embodiments, the protector may comprise a housing configured to at least partially enclose an electrical and/or optical connector and comprising a slot, a latch rotatable with respect to the housing between first rotational position configured to lock the housing to an electronic component and a second rotational position configured to release the housing from the electronic component, and a slider coupled to the latch and biased to engage the slot when the latch is in the first rotational position.

In some embodiments, the slider may be biased to project from the latch to engage the slot and compressible to be disengaged from the slot.

In some embodiments, the latch may comprise a handle and rotational coupling components configured to engage respective sides of the housing, and the slider may be biased to project substantially in a direction from the rotational coupling components to the handle.

In some embodiments, the slider may be positioned closer to the handle than to the rotational coupling components.

In some embodiments, the slider may be spring-loaded to engage the slot when the latch is in the first rotational position.

In some embodiments, the protector may further comprise a spring, wherein the latch comprises a first channel holding a first end of the spring and the slider comprises a second channel holding a second end of the spring.

In some embodiments, the spring may comprise an electrically insulative spring.

In some embodiments, the latch may comprise a clearance area to allow expansion of the electrically insulative spring in a first direction when compressed in a second direction perpendicular to the first direction.

In some embodiments, the electrically insulative spring may comprise an elastomer.

In some embodiments, the electrically insulative spring may comprise silicone.

In some embodiments, the latch may comprise a handle configured to rest atop the slot when the latch is in the first rotational position.

In some embodiments, the housing may comprise a first opening configured to expose a mating interface of the electrical and/or optical connector for engaging a mating connector of the electronic component.

In some embodiments, the housing may further comprise a second opening configured to receive a cable.

In some embodiments, the slot may be positioned closer to the second opening than to the first opening.

In some embodiments, the first opening may be positioned at a first end of the housing, the second opening is positioned at a second end of the housing, and the slot may be positioned closer to the second end than to the first end.

In some embodiments, the first opening may be oriented along an engagement direction, and the latch may be rotatable between the first and second rotational positions about a second axis perpendicular to the engagement direction.

In some embodiments, when the latch is in the first rotational position and the slider is engaged to the slot, the slider may be compressible in a direction parallel to the engagement direction to disengage from the slot.

Some aspects of the present disclosure relate to a protector for a connector. In some embodiments, the protector may comprise a housing configured to support a connector at a first end of the housing, a latch rotatable with respect to the housing between first rotational position configured to lock the housing to an electronic component and a second rotational position configured to release the housing from the electronic component, and a nut configured for coupling to a second end of the housing to secure a cable to the housing and, when the latch is in the first rotational position, to engage the latch.

In some embodiments, the housing may comprise a first opening configured to align with an opening in the electronic component at an engagement interface between the protector and the electronic component.

In some embodiments, the housing may further comprise a second opening configured to receive a cable, wherein the nut is configured for coupling to the housing proximate the second opening.

In some embodiments, the nut may comprise an aperture configured to pass a cable through the aperture to the second opening of the housing.

In some embodiments, the first opening may be oriented for the engagement interface to engage the electronic component along a mating axis and the latch may be rotatable between the first and second rotational positions about a second axis perpendicular to the mating axis.

In some embodiments, the latch may comprise a tongue extending away from an axis of rotation of the latch.

In some embodiments, the latch may comprise a handle extending away from the axis of rotation of the latch, the handle and tongue configured to be disposed on opposing sides of the nut when the nut is coupled to the second end of the housing and engaged to the latch.

In some embodiments, the tongue may be positioned closer to the handle than to the axis of rotation of the latch.

In some embodiments, the latch may comprise first and second arms rotatably coupled to respective sides of the housing such that the axis of rotation passes through the first and second arms.

In some embodiments, the nut may be configured to block rotation of the latch away from the first rotational position when the nut is engaged to the latch and the latch is in the first rotational position.

In some embodiments, the nut may be configured for fastening onto threads at the second end of the housing and the latch comprises a tongue configured to be proximate the threads when the latch is in the first rotational position such that the nut engages the tongue when fastened onto the threads.

Some aspects of the present disclosure relate to an electronic component configured for engaging a protector for a connector. In some embodiments, the electronic component may comprise a bulkhead comprising a housing with a cavity and a protruding wall proximate the cavity and a cap comprising an insert configured to fit within the cavity and a latch rotatably mounted to the insert and configured to engage with a feature of the insert when rotated towards a first position in which the latch locks the plug to the bulkhead.

In some embodiments, the feature of the insert may comprise a compliant member.

In some embodiments, the latch may comprise an opening configured to receive the protruding wall of the bulkhead when the latch is rotated to the first position.

In some embodiments, the latch may be rotatable between a first rotational position in which the latch is pressed against the insert by the feature of the insert and a second rotational position in which the latch is rotatable with respect to the insert.

In some embodiments, the latch may comprise at least one hook configured to engage at least one respective projection of the bulkhead.

In some embodiments, the bulkhead may comprise two protruding walls on opposing sides of the cavity, and the insert is disposed between the two protruding walls.

In some embodiments, the at least one hook may be configured to engage the at least one respective projection of the bulkhead when the latch is in the first rotational position and be disengaged from the at least one respective projection of the bulkhead when the latch is in the second rotational position.

In some embodiments, the at least one hook may comprise first and second hooks positioned on opposing sides of the latch and configured to engage first and second respective projections positioned on opposing sides of the flange.

In some embodiments, the latch may comprise an axle and the insert comprises a feature for receiving the axle such that the latch is hinged to the insert.

### BRIEF DESCRIPTION OF DRAWINGS

The accompanying drawings are not necessarily drawn to scale. For purposes of clarity, not every component may be labeled in every drawing. In the drawings:

FIG. 1 is a perspective view of an exemplary electrical interconnection system, in accordance with some embodiments;

FIG. 2A is a perspective exploded view of the electrical interconnection system 10 of FIG. 1 with the cable 202 removed;

FIG. 2B is a side, partially exploded view of the electrical interconnection system 10 of FIG. 1;

FIG. 3A is a perspective view of the cable termination assembly 300 of FIG. 1 with a protector 205 partially enclosing a cable connector 204;

FIG. 3B is a front view of the cable termination assembly 300 of FIG. 1;

FIG. 4A is a side view of the cable termination assembly 300 of FIG. 1 engaged with the bulkhead 120, with the bulkhead 120 shown partially cut away;

FIG. 4B is a perspective view of a portion of the cable termination assembly 300 of FIG. 1 engaged with the bulkhead 120 as shown in FIG. 4A;

FIG. 4C is a bottom view of the cable termination assembly 300 of FIG. 1 engaged with the bulkhead 120 as shown in FIG. 4A;

FIG. 5 is a perspective view of the protector housing 210 of the cable termination assembly 300 of FIG. 1;

FIG. 6 is a sectioned perspective view of a portion of the protector 205 of FIG. 1 including a spring-loaded locking mechanism according to some embodiments;

FIG. 7 is a perspective view of the latch 230 of the protector 205 of FIG. 1;

FIG. 8 is a sectioned perspective view of a portion of protector 205 of FIG. 1 including a spring-loaded locking mechanism according to some alternative embodiments;

FIG. 9 is a perspective view of the protector 205 of FIG. 1 with an end cap 280;

FIG. 10 is a perspective view of cable termination assembly 1004 that may be included in the electrical interconnection system 10 of FIG. 1, with a locking mechanism according to some alternative embodiments and an exemplary protective cap installed;

FIG. 11A is a top view of a portion of the cable termination assembly 1004 of FIG. 10 showing the locking mechanism in a state with nut 1072 unfastened;

FIG. 11B is a side, cross-section of the cable termination assembly 1004 of FIG. 10 with the nut 1072 unfastened as shown in FIG. 11A;

FIG. 11C is a top view of the cable termination assembly 1004 of FIG. 10 with the nut 1072 fastened;

FIG. 11D is a side, cross-section of the cable termination assembly 1004 of FIG. 10 with the nut 1072 fastened as shown in FIG. 11C;

FIG. 12 is a perspective view of the latch 1030 of the cable termination assembly 1004 of FIG. 10;

FIG. 13 is a perspective view of a cable termination assembly 1304 that may be included in the electrical interconnection system 10 of FIG. 1 with a locking mechanism according to further alternative embodiments and a protective cap installed;

FIG. 14A is a top view of a portion of the cable termination assembly 1304 of FIG. 13 showing the locking mechanism in a state with the slider 1342 disengaged;

FIG. 14B is a side, cross-section of the cable termination assembly 1304 of FIG. 13 with the slider 1342 disengaged as shown in FIG. 14A;

FIG. 14C is a top view of the cable termination assembly 1304 of FIG. 13 with the slider 1342 engaged;

FIG. 14D is a side, cross-section of the cable termination assembly 1304 of FIG. 13 with the slider 1342 engaged as shown in FIG. 14C;

FIG. 15 is an exploded view of a cable termination assembly 1504 that may be included in an electrical interconnection system with an optoelectronic component serving as a cable connector, in accordance with some embodiments;

FIG. 16 is a perspective view of a board connector 1610 that may be configured to receive the mating interface of the optoelectronic component of FIG. 15, in accordance with some embodiments;

FIG. 17 is a perspective view of a bulkhead with an exemplary cap in accordance with some embodiments sealing an opening through the bulkhead;

FIG. 18 is a perspective view of the cap 1702 of FIG. 17; and

FIG. 19 is an exploded view of the cap 1702 of FIG. 17.

### DETAILED DESCRIPTION

The inventors have recognized and appreciated features for a connector protector that enable robust environmental protection for the connector and/or an electronic assembly to which the connector is mated, even if large forces are applied on the protector. A protector for a cable connector, for example, may be coupled to a cable that, in use, is routed through an environment in which unwanted forces may be applied on the cable. An animal might jump on the cable, for example, which would impart a force on the protector that could interfere with the sealing between the protector and an enclosure for the electronic assembly.

The inventors have recognized and appreciated that a more robust protector may be provided with a latch in combination with one or more features that can withstand forces that may be applied through the cable. Those forces may be transverse to an engagement direction in which the protector is moved to engage an electronic enclosure and/or may be parallel to an axis around which the latch rotates to lock or unlock the protector from the electronic assembly. Such a feature may act as a stabilizer limiting motion, whether translational or rotational or both, of the latch and/or a housing of the protector in the direction of those forces and/or in a plane transverse to the engagement direction. Examples of a stabilizer include a member between arms of a latch that engage features coupled to the electronic enclosure and/or a lip on a housing of the protector that fits between sidewalls of a bulkhead coupled to the electronic enclosure.

Moreover, the inventors have recognized and appreciated features that enable simple operation of the protector, which may include features that result in a secondary locking mechanism, in addition to the locking achieved with the latch, being engaged without explicit user action. Such features may increase the likelihood that the protector is securely engaged to the electronic assembly, which may in turn increase the protection provided by the protector. Examples of such a secondary locking mechanism include a biased slider that engages the protector from the latch and/or a nut that may engage the latch when fastened to the cable end of the protector, in either case securing the latch in the locked position.

Further, the inventors have recognized and appreciated that an attachment interface on a bulkhead designed to engage with the protector may, when the protector is not coupled to the bulkhead, securely engage a cap. A latching mechanism of the cap may create a sound when moved into a latched position and may be retained in that position by a snap feature. The cap may seal an opening through the bulkhead when the protector is not latched to the bulkhead, preventing moisture, dust and other contaminants from entering the enclosure of the electronic assembly through the bulkhead.

The cap alternatively or additionally may limit electromagnetic interference (EMI) associated with radiation passing through the opening in the bulkhead. EMI can be caused by or interfere with electronic components inside the electronic assembly. EMI may be blocked by a metal structure acting as a shield, such as a metal component held in place by the cap, such as by attaching a metal sheet to outer surfaces of the cap or otherwise holding a metal sheet in the bulkhead opening. Alternatively or additionally, part of all of the cap may be formed of metal.

These features may be used separately or one or more such features may be used together.

Accordingly, the present disclosure provides a robust protector capable of protecting an electrical interconnection system from the external environment.

A protector may be fitted around an electrical and/or optical connector to protect the connector from external elements (e.g., dust, dirt, moisture, and/or liquid) to facilitate implementation of an electrical interconnection system in an outdoor or other environment prone to such elements. In some embodiments, such protectors may include robust latching mechanisms for locking the protector to a bulkhead, to provide a reliable seal between the protector and bulkhead and/or prevent unintentional disengagement of the connector inside the protector due to externally applied forces, which may be caused by interference from animals, for example. At the same time, such latching mechanisms may be easy for an operator to use to engage or disengage the connectors.

The inventors recognized and appreciated that electrical interconnection systems employed in outdoor or other harsh environments are prone to externally applied forces of 100 N, 150 N, or higher caused by forces on the cables. In an outdoor environment, for example, squirrels and other animals may jump on the cables, applying a relatively large force on the cable that is transferred to the connector protector. Without sufficient resistance to such externally applied forces, the protector may disengage from a bulkhead to which it is attached. The environmental resistance provided by the protector is lost and the coupling of signal through the connectors enclosed by the protector may be compromised, interrupting operation of the devices connected by the system. Alternatively or additionally, applied forces insufficient to disengage the protector may still be strong enough to interfere with the positioning of environmental seals between the protector and the adapter, making the connector system prone to dust, dirt, and/or moisture exposure.

According to an aspect of the present disclosure, a protector for a connector, such as an electrical and/or optical connector, may include stabilizing features that improve resistance to high externally applied forces, including forces that are transverse to the engagement direction between the protector and a bulkhead. The protector, for example, may have a latching mechanism that can readily withstand relatively large forces that are opposite the direction in which the protector is moved to engage the bulkhead, but may be more susceptible to transverse forces. A protector for a cable connector incorporating some or all of these features may withstand loads on the cable of 150 N for at least 180 seconds, including such forces that are perpendicular to the engagement direction.

the protector may include a protector housing and a latch that is rotatable with respect to the housing to lock and unlock the protector housing from an electronic component. As an example of stabilizing features that may be incorporated into a protector, and the protector may further include a stabilizer configured to limit movement of the latch in a direction parallel to the axis of latch rotation. As one example, the latch may have arms rotatably coupled to opposing sides of the protector housing, and the stabilizer may include a stabilizing member connecting the arms of the latch on a third side of the protector housing. In this example, the stabilizing member limits movement of the latch by keeping the arms of the latch from moving away from one another, as such movement may cause the arms to decouple from a bulkhead to which the protector is engaged. Alternatively or additionally, the stabilizer member may distribute force exerted on one part of the latch to another part of the latch, such as from one arm to another arm of the latch, making the latch less susceptible to decoupling.

As an alternative or additional example, a protector for an electrical and/or optical connector may have a protector housing including a lip portion proximate a port of the protector that exposes the connector for mating. For example, the lip portion may have exterior surfaces configured to engage interior surfaces of the electronic component (e.g., the bulkhead) to limit movement of the protector housing with respect to the electronic component when engaged thereto in a mating direction. In this example, twisting and/or translating the protector housing with respect to the electronic component in the plane normal to the engaging direction may be limited by engagement of the exterior surfaces of the lip portion of the protector housing against interior surfaces of the bulkhead, thereby improving the robustness of the interconnection system, including with respect to transverse forces. In some examples, lip portions on opposing sides of the protector may be configured to engage the engage the bulkhead to block rotation and/or translation of the protector housing in a plane perpendicular to the engagement direction. For example, the lip portions may protrude from the protector housing in directions perpendicular to the engagement direction to press against surfaces of the bulkhead when the protector housing is rotated about an axis perpendicular to the engagement direction and perpendicular to the protruding directions of the lip portions. In this example as well, the robustness of the interconnection system is improved.

According to another aspect of the present application, a protector for an electrical and/or optical connector may include features that provide a secondary enclosure of the environmental seals of the connector for improved resistance to external elements, even in the presence of externally applied force that might otherwise interfere with the seals. In some embodiments, an electrical and/or optical connector inside a protector may be surrounded by a seal. The protector may have an opening oriented in a first direction to expose the connector for mating. The housing may include a lip portion proximate the opening and extending beyond the seal of the connector in a second direction perpendicular to the first direction. For example, the housing may be configured to at least partially compress the seal between the housing and an electronic component when the housing and electronic component are engaged to provide environmental protection for the interface therebetween. In this example, when the housing is pushed or pulled by an externally applied force, the protruding lip portion of the housing may engage a portion of the electronic component and block the seal from being exposed to external elements, thereby reinforcing the environmental protection provided by the seal.

According to another aspect of the present application, a protector for an electrical and/or optical connector may include an automatic latch-locking mechanism. In some embodiments, the latch-locking mechanism may include a biased slider lock. For example, a protector may include a protector housing with a slot and a latch that is rotatable with respect to the housing to latch the protector housing to an electronic component when the latch is in a first rotational position and to release the protector housing from the electronic component when the latch is in a second rotational position. The protector may further include a slider coupled to the latch and biased to engage the slot of the protector housing when the latch is in the first rotational position, which in this example is a locked position. In some embodiments, the slider may be spring-loaded with respect to the latch to project out from the latch to engage the slot of the protector housing without express user action beyond rotating the latch to the first rotational position. The slider may be disengaged from the slot to unlock the latch by pushing the slider against the biasing force. For example, the latch may be automatically locked when rotated to the locked position for easy operation, and biasing the slider makes it harder for externally applied forces (e.g., other than a human operator) to rotate the latch out of the locked position and disengage the protector from the electronic component.

In some embodiments, an automatic latch locking mechanism may include a nut configured to engage the latch when the nut is coupled to the housing with the latch in a locked position. For example, a protector may include a housing, a latch rotatable with respect to the housing between first and second rotational positions, and a nut configured for coupling to an end of the housing to secure a cable to the housing and to engage the latch when the latch is in one of the rotational positions which serves as a locked position. In this example, when the latch is in a locked position, the nut may be coupled to the end of the housing to secure the cable to the housing and lock the latch in one action, making operation easy and making it harder for undesired forces to rotate the latch out of the locked position.

According to another aspect of the present application, a cap that engages a bulkhead configured for coupling to a protector as described herein may provide environmental protection to an enclosure to which the bulkhead is attached and/or suppress electromagnetic interference caused by radiation passing through an opening in the bulkhead. The cap may include an insert, shaped to fit within an opening in the bulkhead, and a locking mechanism that engages features on the bulkhead. The locking mechanism may provide strong locking such that it is resistant to externally applied forces that may inadvertently remove the cap from the bulkhead. The locking mechanism in some examples may include a latch that is rotatable with respect to the insert. Strong retention may be facilitated with a snap on the insert that engages features on the lever to hold the lever in a locked position. That snap may have a rounded surface on a compliant member. The compliant member may be configured such that, as the lever is pushed towards the locked position, the compliant member is deflected. Once the lever is rotated over the apex of the rounded surface, the retained force in the compliant member may generate a camming force at the rounded surface that urges the lever towards the locked position. That force may drive the lever towards a surface of the insert with sufficient force to make a clicking or snapping sound, signaling to a user that the cap is firmly locked in place, increasing the likelihood that the cap will be firmly secured in use.

It should also be appreciated that aspects of the present application may be used individually or in any combination, as embodiments described herein are not so limited.

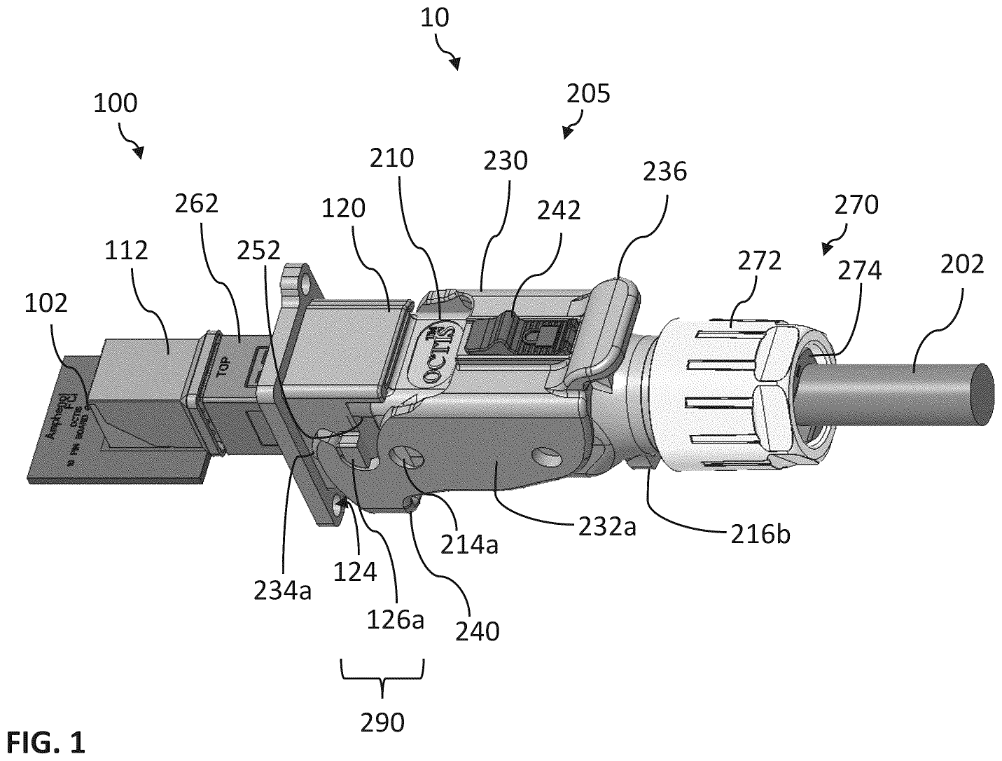

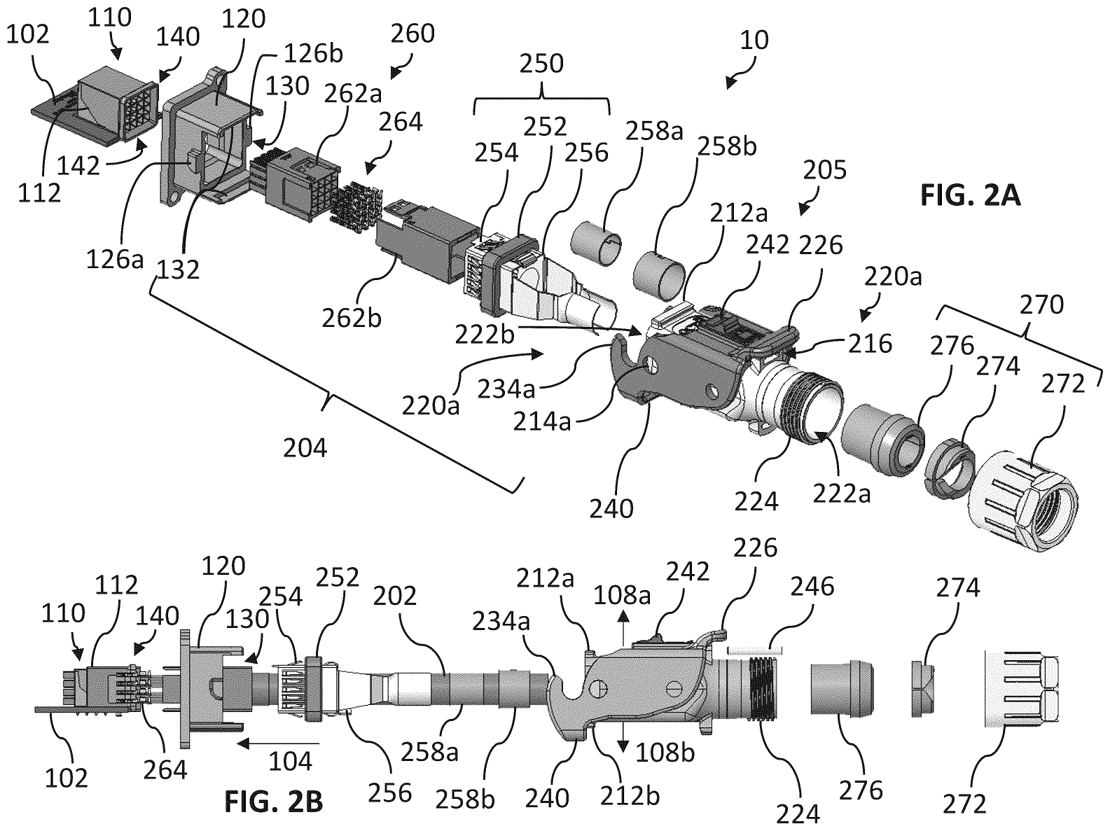

FIGS. 1, 2A and 2B illustrate an example electrical interconnection system 10, in accordance with some embodiments. FIG. 1 is a perspective view of interconnection system, FIG. 2A is an exploded view without cable 202 and FIG. 2B is an exploded side with the end of cable 202 within the interconnection system shown. In the example illustrated, interconnection system 10 makes connections between a cable 202 and an electronic assembly 100.

The interconnection system 10 here includes a cable connector 204 terminating cable 202. In use, cable 202 may extend from interconnection system 10 to a remote location where it may be connected to another electronic assembly. For simplicity of illustration, the full length of cable 202 is not shown, and its termination at the remote end is not illustrated.

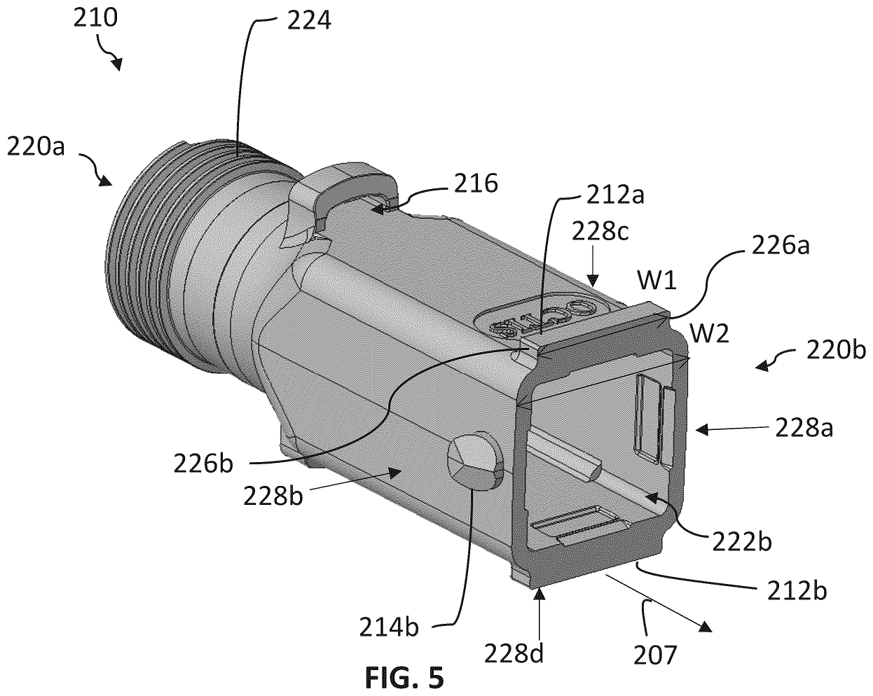

The cable connector 204 is within a protector 205 that has a first opening (222a, FIG. 2A) through which cable 202 passes. Protector 205 may also have a second opening (222b, FIG. 5) through which the connector may mate with the electronic assembly 100. In the illustrated example, a mating interface 140 of cable connector 204 extends through second opening (222b).

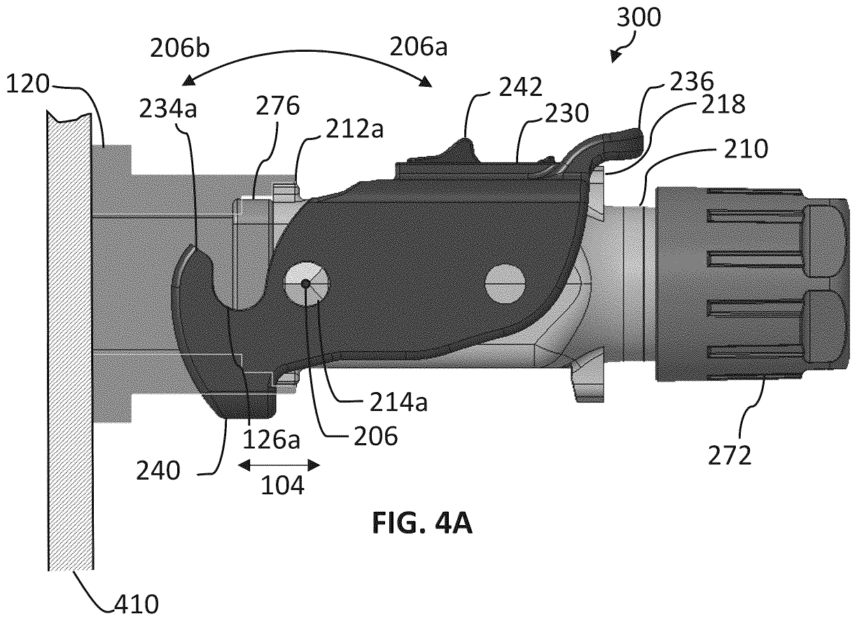

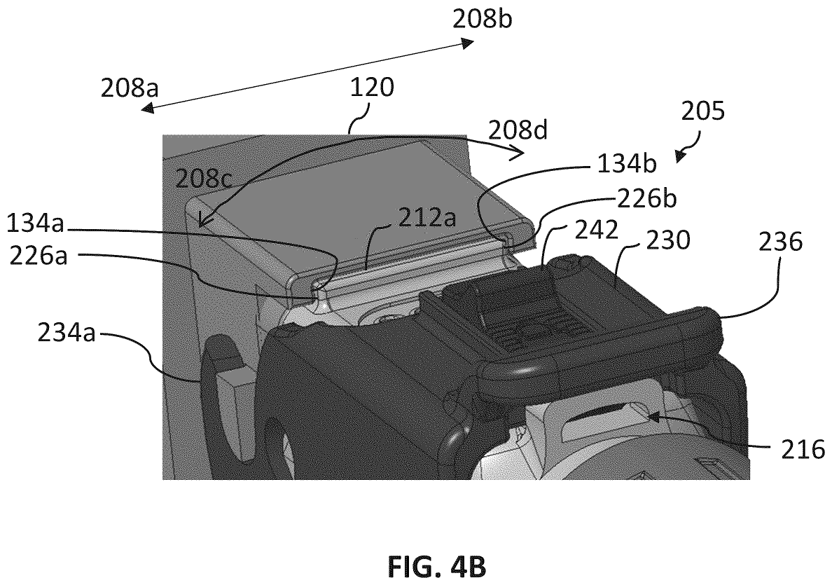

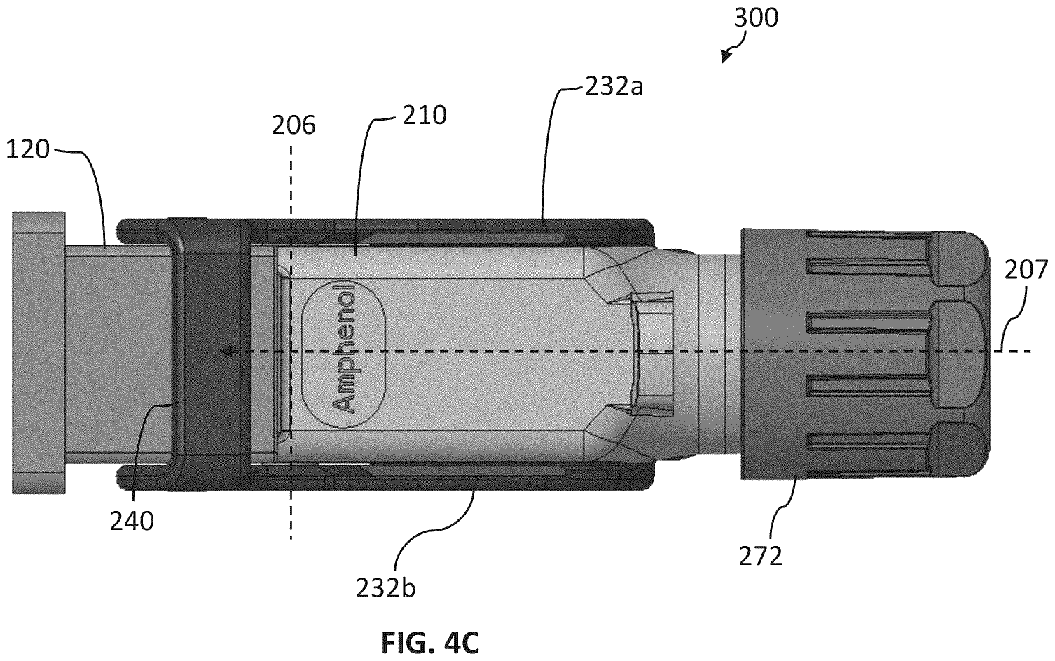

In the illustrated example, the mating interface 140 of cable connector 204 extends through and beyond second opening 222b and into an enclosure of the electronic assembly 100. Bulkhead 120 may be mounted to a panel of the enclosure, such as panel 410 shown schematically in FIG. 4A. An opening of bulkhead 120 may be aligned with an opening of the panel. Bulkhead 120 may be mounted to a panel with a gasket, adhesive or other mechanism to provide a seal between bulkhead 120 and the panel. For simplicity of illustration, panels forming an enclosure for electronic assembly 100 are not expressly illustrated in FIG. 1, but bulkhead 120 may be mounted to or integrally formed with such a panel. 122.

In operation, when protector 205 for the cable connector 204 is attached to the bulkhead 120, a portion of cable connector 204 extends through the opening in bulkhead 120 and the corresponding opening in the panel to which bulkhead 120 is attached. In this configuration, cable connector 204 mates with a board connector 110, which in this example is mounted to a substrate 102, such as a printed circuit board (PCB) inside electronic assembly 100. For simplicity of illustration, semiconductor devices and other electronic components that may be mounted to substrate 102 are not expressly illustrated. Other components, such as power supplies, network interfaces and daughter cards which may also form electronic assembly 100 are not expressly shown, but any number and type of such components may be inside the enclosure for electronic assembly 100 and may generate and/or receive signals that pass through board connector 110 and cable connector 204. In some embodiments, board connector 110 may include signal and/or power contacts configured to engage signal and/or power contacts of cable connector 204. For example, the contacts of board connector 110 may include mating contacts (e.g., pins, blades, and/or compliant fingers) arranged in an array. In this example, the contacts may also have contact tails (e.g., press fit and/or solder mount tails) mounted to conductive holes and/or pads of substrate 102. In this manner, the board connector 110 may electrically connect conductive traces on the substrate 102 to cable connector 204 when board connector 110 engages cable connector 204.

In FIG. 1, board connector 110 includes a housing 112 supporting the contacts of the connector 110. In some embodiments, housing 112 may include a conductive exterior and/or a conductive shell may be disposed around housing 112 to limit electromagnetic interference (EMI). For example, the conductive exterior and/or shell may be electrically connected to ground.

In some embodiments, board connector 110 may have a mating interface 140 for engaging cable connector 204. For example, as shown in FIGS. 2A-2B, housing 112 has channels 142 in which contacts may be disposed, such as pin contacts that may be inserted into receptacle contacts of cable connector 204.

Bulkhead 120 may be configured to form a seal with a protector 205, providing environmental protection for board connector 110 and other components of the electronic subassembly including PCB 102, board connector 110, bulkhead 120. For example, as shown in FIG. 1, bulkhead 120 includes a housing, which may be formed using a robust material such as die cast metal or hard plastic. In some embodiments, bulkhead 120 may be configured for fastening to a panel of an enclosure. For example, bulkhead 120 is shown in FIG. 1 including fixing holes 124, which may be screwed to a surface to secure the bulkhead 120 to a panel. In the illustrated embodiment, a single bulkhead 120 is shown, though in other embodiments, bulkhead 120 may be one of a plurality of bulkheads.

In some embodiments, bulkhead 120 may be configured to mechanically engage a protector for a connector at an engagement interface 290. Each of protector 205 and bulkhead 120 may include features that cooperate to form the engagement interface 290 For example, bulkhead 120 is shown in FIG. 1 including projections, of which projection 126a is labeled in FIG. 1, which a latching mechanism of the protector may be configured to hook onto to secure the protector to bulkhead 120. The engagement interface 290 may support a stable mechanical connection and/or an environmental seal between bulkhead 120 and protector 205.

Bulkhead 120 may include a cavity 130 aligned with mating interface 140 of board connector 110. A portion of cable connector 204, including the mating interface may extend through cavity 130 to mate with board connector 110. In the illustrated embodiment, bulkhead 120 includes protruding walls on opposing sides of cavity 130 with grooves 132 in the protruding walls. In some embodiments, features of protector 205 may be configured to engage the grooves 132, as described further herein.

In some embodiments, protector 205 may have a protector housing 210 with openings for receiving cable 202 and exposing mating interface 260 of cable connector 204. For example, as shown in FIGS. 2A-2B, protector housing 210 has a first opening 222a (FIG. 5) at a first end 220a for receiving cable 202 and a second opening 222b at a second end 220b through which mating interface 260 extends. In some embodiments, second opening 222b may be oriented along a mating direction 104 in which cable connector 204 mates with board connector 110 permitting contacts 264 of mating interface 260 to engage contacts of board connector 110.

In some embodiments, protector 205 may include a cable interface 270. For example, as shown in FIGS. 2A-2B, housing 210 has threads 224 at first end 220a to which a nut 272 may be fastened to secure cable 202 to housing 210.

As shown in FIG. 1, protector 205 includes a cable interface 270 that secures protector 205 to cable 202 and may form an environmental seal between protector 205 and cable 202 to.

Cable 202 may include conductors configured to carry power (e.g., AC and/or DC power). Alternatively or additionally, cable 202 may include conductors configured to carry signals (e.g., single-ended or differential signals), such as in a coaxial or twin-axial configuration. In some embodiments, cable 202 may be configured as an optical cable including one or more optical waveguides (e.g., fibers) supporting transmission of optical signals. In examples in which cable 202 contains electrical conductors, cable connector 204 may include contacts, which may be power and/or signal contacts, connected to conductors of cable 202. In examples in which cable 202 contains optical fibers, the connections to contacts in cable connector 204 may be made through a transceiver. and the contacts of cable connector 204 may form a mating interface for mating with contacts of board connector 110. In the illustrated embodiment, contacts 264 are oriented along mating direction 104, as contacts 264 are arranged in an array in the plane normal to mating direction 104.

In the illustrated example, connector 204 has a mating interface 260 with contacts 264 configured for mating with contacts of connector 110 of electronic assembly 100. As shown in FIGS. 2A-2B, contacts 264 are configured as receptacle contacts with cable termination portions at one end and receptacles at the other end so as to bring conductors within cable 202 into communication with contacts of board connector 110.

In the example illustrated, cable connector 204 further includes a two-piece housing 262 with contacts 264 held between a first housing member 262a and a second housing member 262b. Front housing member 262a has pillars with interior channels for holding contacts 264. When engaged to a mating connector, the pillars of first housing member 262a may be inserted within channels of the mating connector. In the example illustrated, second housing member 262b has compliant arms for engaging interfering protrusions on sides of first housing member 262a to secure the housing members 262a and 262b to one another. In some embodiments, first and second housing members 262a and 262b may be formed using insulative material, such as molded plastic.

As shown in FIGS. 2A-2B, connector 204 further includes a shield assembly 250 with an EMI shield 254. In the illustrated embodiment, EMI shield 254 is fitted around second housing member 262b to surround the interface between cable 202 and contacts 264. In some embodiments, EMI shield 254 may be formed using conductive material and may, for example, be stamped from a sheet of metal. In the illustrated embodiment, wings 256 extends from EMI shield 254 and are shaped to electrically and mechanically engage cable 202.

In some instances, cable 202 may include a cable shield, such as a conductive film or braid, which is exposed at the end of the cable to be terminated to connector 204. Wings 264 may be electrically connected to the cable shield. In this example, the electrical and mechanical connections are made through ferrule 258s and crimp band 258b. In this example, ferrule 258a may surround cable 202 under wings 256. Ferrule 258a may, in various examples, be threaded over the cable over the cable shield or may be inserted under the cable shield. Ferrule 258a may align with the distal ends of wings 256, which are curved to conform to ferrule 258a. Crimp band 258b may be slid over the distal ends of wings 256 and crimped. Such an approach may capture wings 256 between ferrule 258a and crimp band 258b, mechanically and electrically connecting shield assembly 250 to the cable.

Protector 205 may be configured to protect the interfaces of cable connector 204 from external elements such as moisture, dirt, dust, and/or to prevent such contaminants from entering the electronic assembly through an opening in a panel of the enclosure through which a cable connector is inserted. Protector 205 may alternatively or additionally isolate the cable connector from externally applied forces that could otherwise cause cable connector 204 to disengage from board connector 110 or otherwise interfere with reliable mating of those connectors. For example, in FIGS. 1 and 2A-2B, protector housing 210 is shown as an enclosure around cable connector 204 with openings that permit cable 202 to enter housing 210 and contacts 264 of cable connector 204 to be exposed for mating with another connector. In some embodiments, protector housing 210 may be formed of a robust insulative material such as hard plastic.

In some embodiments, protector housing 210 may be configured to cooperate with nut 272 to seal cable 202 from the external environment. For example, as shown in FIGS. 2A-2B, tightening nut 272 may compress a cone 274 and force gland 276 between housing 210 and cable 202 to seal gaps around cable 202.

In some embodiments, protector 205 may be configured to engage a bulkhead 120. Such an engagement may transmit force from the protector 205 to bulkhead 120 through a force transfer path that does not include cable connector 204. With such an engagement, the impact on the mated connectors of forces applied to protector 205 and/or cable 202, which is coupled to protector 205, is lessened. Such engagement may also provide environmental sealing. For example, as shown in FIG. 1, seal 252 is between protector 205 and bulkhead 120. FIGS. 2A and 2B illustrate seal 252 mounted over a portion of shield 254. In the assembled connector, wings 256 may extend into opening 222b of protector 205 such that they are within the housing of protector 205. Seal 252 may be sized and positioned to press against an outside, forward-facing surface of the housing of protector 205 that opposes to oppositely facing surfaces of bulkhead 120.

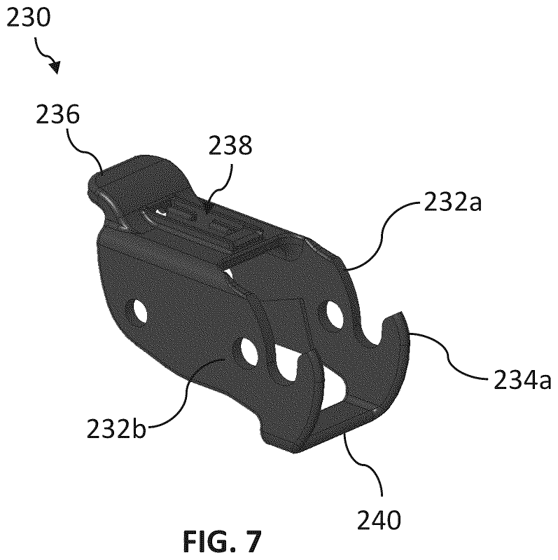

In some embodiments, protector 205 may be configured for latching to bulkhead 120. For example, as shown in FIG. 1, protector 205 further includes a latch 230. In some embodiments, latch 230 may be rotatable with respect to protector housing 210. For example, in FIG. 1, latch 230 includes arms 232a and 232b (FIG. 7). In some embodiments, arms 232a and 232b of latch 230 may have rotatable coupling members configured to engage rotatable coupling members on respective sides of protector housing 210. For example, in FIG. 1, protector housing 210 includes projections 214a and 214b (FIG. 5), and arms of latch 230 have holes shaped to fit around the projections that may serve as hubs for rotation of latch 230. Alternatively, the arms of latch 230 may include projections and sides of protector housing 210 may have recesses to serve as hubs.

Also shown in FIGS. 1 and 2A-2B, latch 230 includes a handle 236 that a user may grasp to rotate latch 230 with respect to protector housing 210. In the illustrated embodiment, handle 236 is at an opposite end of latch 230 from the latching members on arms 232a and 232b.

In some embodiments, latch 230 may rotatable between a locked position, in which latch 230 is engaged to bulkhead 120, and an unlocked position, in which latch 230 is disengaged from bulkhead 120. For example, FIG. 1 shows latch 230 in a locked position engaged to bulkhead 120. In some embodiments, latch 230 may be configured to, when rotated to the locked position, provide a force urging protector housing 210 toward bulkhead 120. For example, in FIG. 1, arms 232a and 232b of latch 230 terminate in hooks 234a and 234b (FIG. 7), that may be configured to engage projections of bulkhead 120. In the illustrated embodiment, when latch 230 is rotated in a first rotational direction (e.g., rotating handle 236 toward protector housing 210), hooks of latch 230 may pull bulkhead 120 toward protector housing 210. Likewise, in the illustrated embodiment, rotating latch 230 in a second rotational direction (e.g., rotating handle 236 toward bulkhead 120) may disengage hooks of latch 230 from bulkhead 120, allowing protector housing 210 and bulkhead 120 to be separated. In some embodiments, latch 230 may have an angular range of unlocked rotational positions and/or a range of locked rotational positions, depending on the particular application. In some embodiments, seal 252 may be at least partially compressed between protector housing 210 and bulkhead 120 when protector 205 is engaged to bulkhead 120.

In some embodiments, latch 230 may be rotatable between locked and unlocked rotational positions about a latch rotation axis 206 (FIG. 4C) perpendicular to an engagement direction 207 in which protector is moved to engage bulkhead 120. In this example, the engagement direction 207 is parallel to the mating direction 104 of the cable connector within the protector. Such a configuration may enable the cable connector inside the protector to mate with a connector inside the electronic component in the same motion used to engage protector 205 to a bulkhead 120 on an exterior of the electronic component. In the example illustrated, the latch rotation axis 206 runs through the rotational coupling members of protector housing 210 and latch 230. In the example of FIGS. 4A-4C, latch 230 is in the locked position, rotated in a first rotational direction 206a (FIG. 4A) about latch rotation axis 206 toward cable end 220a, from which latch 230 may be rotated in a second rotational direction 206b (FIG. 4A) toward mating interface end 220b to the unlocked position.

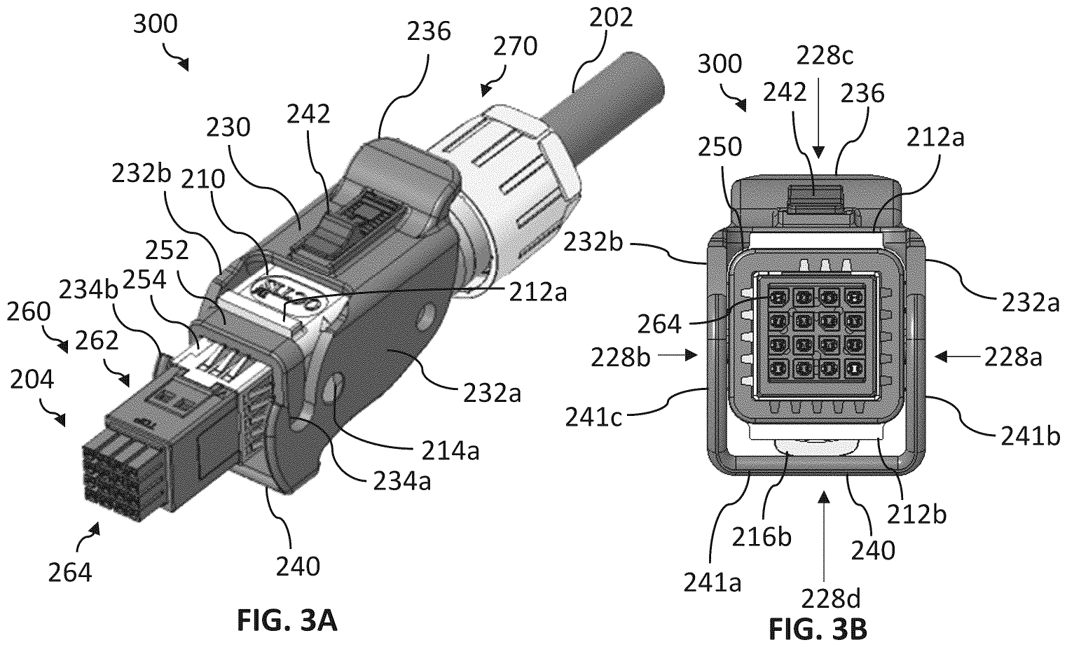

In some embodiments, protector 205 may have features that enhance the robustness of a cable connector assembly in the presence of external forces that might otherwise disrupt the mechanical connection between protector 205 and bulkhead 120 or weaken the environmental seal between protector 205 and bulkhead 120. For example, as shown in FIGS. 1 and 2A-2B, latch 230 may include a stabilizer member 240 configured to resist forces on the protector in in a direction parallel to the latch rotation axis, as described herein in connection with FIGS. 3A-3B.

Alternatively or additionally, protector 205 may include one or more portions that protrude to engage bulkhead 120 to restrain movement of protector 205 with respect to bulkhead 120 in response to forces in a direction parallel to the latch rotation axis. For example, as shown in FIGS. 1 and 2A-2B, protector housing 210 has portions 212a and 212b protruding in directions transverse to engagement direction 207 that may be configured to engage grooves 132 of bulkhead 120, as described herein in connection with FIGS. 4A-5.

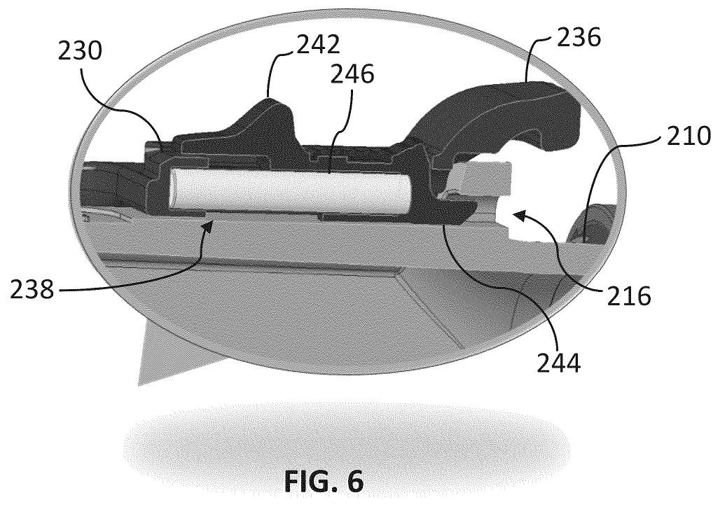

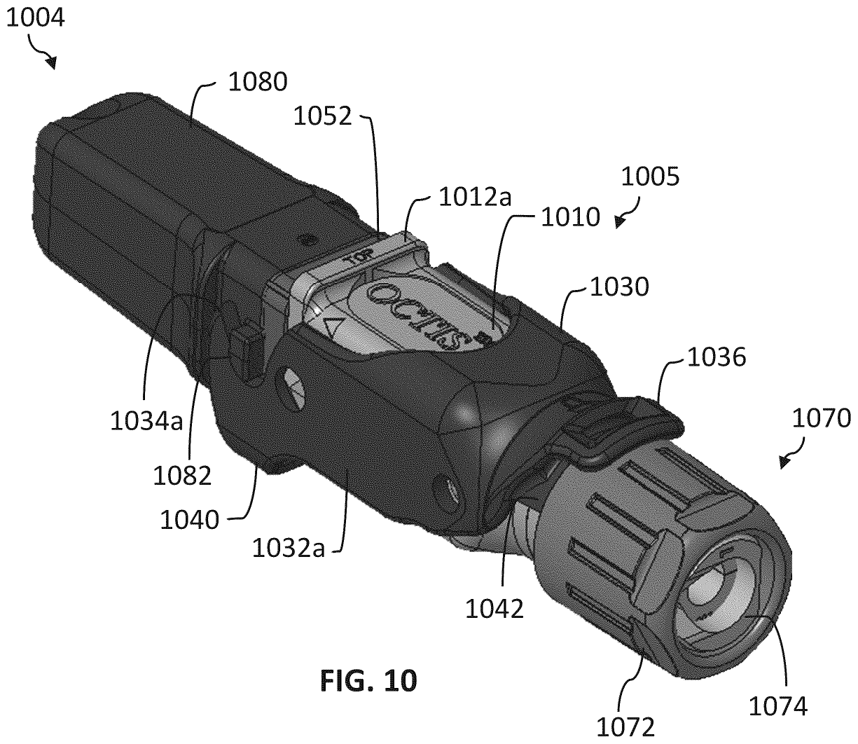

In some embodiments, protector 205 may further include a locking mechanism to secure latch 230 in the locked position, thereby preventing the undesired unlocking of latch 230 by external forces. The locking mechanism may be configured to automatically engage as part of a user attaching a cable termination assembly 300 with a protector 205 as described herein to an electronic assembly, such that a user need not take any additional explicit steps to engage the locking mechanism. As shown in FIGS. 1 and 2A-2B, protector 205 includes a slider 242 atop latch 230 that may be engaged automatically to secure latch 230 in the locked position, as described further herein in connection with FIGS. 6-8. Alternatively or additionally, the nut that secures cable 202 to protector housing 210 may be configured to engage a portion of the latch to secure the latch in the locked position when the nut is fastened to the protector housing, as described herein in connection with FIGS. 10-12.

FIG. 3A is a perspective view of the cable termination assembly 300 including connector 204 and protector 205 of FIG. 1. FIG. 3B is a front view of the cable termination assembly 300. FIGS. 3A-3B illustrate an exemplary implementation of a connector with multiple stabilizing members. In this example, latch 230 includes a stabilizing member 240 connecting arms 232a and 232b of latch 230. In some embodiments, member 240 may maintain the distance between arms 232a and 232b when force is applied to latch 230. The inventors have recognized and appreciated that protectors may be particularly susceptible to forces, including impulsive forces, that are perpendicular to engagement direction 207 or that are transverse to engagement direction 207 such that there is a force component perpendicular to engagement direction 207. In some scenarios, forces that might tend move, such as by translation or rotation, the engagement interface of protector 205 in a direction perpendicular to the engagement direction 207 and parallel to axis 206 may be disruptive to mechanical engagement and/or environmental sealing between the protector 205 and bulkhead 120. Accordingly, one or more stabilizing members may be included to resist such movement.

For example, when cable 202 is pulled to the side of arm 232a or arm 232b, member 240 may prevent arms 232a and 232b from separating to the extent that a hub of arm 232a or 232b disengages the protrusions 214a or 214b. Alternatively or additionally, member 240 may distribute force from the cable 202 exerted on arm 232a of latch 230 to arm 232b. Even force distribution may make it less likely that the latches on either or both arms 232a and 232b deforms or breaks off from latch 230, making disengagement from bulkhead 120 less likely.

In the illustrated embodiment, first arm 232a of latch 230 is coupled to a first side 228a of protector housing 210, second arm 232b of latch 230 is coupled to a second side 228b of protector housing 210, handle 236 connects first and second arms 232a and 232b on a third side 228c of protector housing 210, and member 240 connects first and second arms 232a and 232b on a fourth side 228d of protector housing 210. As can be seen, member 240 and handle 236 are on opposite sides of axis of rotation 206, which enables the latch to rotate between the locked and unlocked positions.

In some embodiments, member 240 may be disposed around multiple sides of protector housing 210. For example, as shown in FIGS. 3A-3B, first and second sides 228a and 228b are opposite one another in a direction in which member 240 is at least partially elongated. Also shown in FIGS. 3A-3B, member 240 is configured as a bar including a first segment 241a elongated in the direction from first side 228a to second side 228b, a second segment 241b connecting first segment 241a to first arm 232a, and a third segment 241c connecting first segment 241a to second arm 232b.

In some embodiments, member 240 may be disposed on at least three sides of protector housing 210. For example, protector housing 210 has a substantially rectangular portion that includes first, second, third, and fourth sides 228a-d, with member 240 disposed along at least a portion of each of first side 228a, second side 228b, and fourth side 228d. In the illustrated embodiment, first side 228a and second side 228b are substantially parallel to one another and third side 228c and fourth side 228d are substantially parallel to one another.

Alternatively or additionally, a protector may include as stabilizing members one or more features that engage with bulkhead 120 to resist translation and/or rotation. Those features may be protruding portions that resist translation and/or rotation in a plane perpendicular to the engagement direction 207 and parallel to axis 206. In this example, protruding portions 212a and 212b of protector housing 210 may be disposed on the same side and the opposite side of protector housing 210 as member 240. For example, as shown in FIGS. 3A-3B, portion 212a is on third side 228c, opposite member 240, and portion 212b is on fourth side 228d, the same side as member 240. These protruding portions may extend from the protector housing in a plane perpendicular to the engagement direction 207 and parallel to axis 206.

In some embodiments, the illustrated configuration may provide stabilization of cable connector 204 through the combination of member 240 and portions 212a and 212b. For example, protector 205 including at least one member 240, portion 212a, and/or portion 212b may be configured to limit movement of latch 230 in response to applied force up to 100 Newtons (N). As another example, protector 205 including member 240 and portions 212a and 212b may be configured to limit movement of latch 230 in response to applied force up to 150 N. Such stabilization may be provided even for side forces, which might otherwise force the protector in a direction to cause translation or rotation in a plane perpendicular to the engagement direction 207 and parallel to axis 206.

In some embodiments, member 240 may be configured to engage bulkhead 120 to stabilize cable connector 204 with respect to bulkhead 120 in the presence of externally applied force. For example, member 240 may be configured to engage bulkhead 120 when latch 230 is rotated to the locked position and disengage bulkhead 120 when latch is rotated to the unlocked position. In this example, member 240 may be closer to an exterior surface of bulkhead 120 when latch 230 is in the locked position than when latch 230 would be in the unlocked position. Member 240 may limit rotation of latch 230 by abutting bulkhead 120 when so rotated. Alternatively or additionally, member 240 may contact bulkhead 120 to transfer force from arm 232a and/or 232b of latch 230 onto bulkhead 120. In the illustrated embodiment, the rotational coupling members of latch 230 and protector housing 210 are closer to second opening 222b (FIG. 2A) than to first opening 222a (FIG. 2A), and member 240 is closer to the rotational coupling members than to first opening 222a.

FIG. 4A is a side view of the cable termination assembly 300 of FIG. 1 engaged with the bulkhead 120, with portions of the walls of bulkhead 120 cut away to reveal portions 212a and 212b. Engagement projection 126a is not visible but may be present though not visible in this cutaway view. As can be seen portions 212a and 212b extend into grooves 132, but portions of the sidewalls of bulkhead 120 bounding groove 132 are not visible in this cutaway view.

FIG. 4B is a perspective view of a portion of the cable termination assembly 300 of FIG. 1 engaged with the bulkhead 120 as shown in FIG. 4A. In this view, portion 212a is seen extending into a groove 132, which is bounded by interior surfaces 134a and 13b of sidewalls of bulkhead 120. Such an arrangement may resist translation and or rotation of protector 205 in response to side forces on protector 205 or cable 202 coupled to protector 205.

FIG. 4C is a bottom view of the cable connector 204 of FIG. 1 engaged with the bulkhead 120 as shown in FIG. 4A. In this view, an engagement direction 207 is illustrated, as is an axis of rotation 206, which in this example is perpendicular to the engagement direction.

FIG. 5 is a perspective view of the protector housing 210 of the cable connector 204 of FIG. 1.

In some embodiments, protector 205 may have features configured to limit movement of protector 205 with respect to bulkhead 120 in the presence of externally applied force. For example, as shown in FIGS. 4A-5, protector housing 210 has portions 212a and 212b that may be configured to engage bulkhead 120 to limit movement of cable connector 204 with respect to bulkhead 120 in a plane normal to the engagement direction 207. In some embodiments, portions 212a and 212b may have exterior surfaces 226a and 226b configured to engage interior surfaces of bulkhead 120 when protector housing 210 engages bulkhead 120. For example, as shown in FIG. 5B, exterior surfaces 226a and 226b face interior surfaces 134a and 134b of sidewalls bounding grooves 132 of bulkhead 120. In the illustrated embodiment, exterior surfaces 226a and 226b of portions 212a and 212b face in directions that are transverse to engagement direction 207 and to the directions in which portions 212a and 212b protrude from the body of protector housing 210.

In some embodiments, exterior surfaces 226a and 226b of portions 212a and 212b may be configured to press against respective interior surfaces 134a and 134b of grooves 132 of flange 122 when protector housing 210 is moved in the plane normal to engagement direction 207, thereby limiting such movement. For example, when protector housing 210 is translated in a first direction 208a transverse to engagement direction 207 or rotated in a first rotational direction 208c about an axis parallel to engagement direction 207, first exterior surface 226a may press against interior surface 134a of cavity 130 of bulkhead 120. Likewise, when protector housing 210 is translated in a second direction 208b transverse to engagement direction 207 or rotated in a second rotational direction 208d about an axis parallel to engagement direction 207, second exterior surface 226b may press against interior surface 134b of cavity 130 of bulkhead 120.

The inventors have recognized and appreciated that engagement between portions 212a and 212b and side walls of the bulkhead 120 reduces force transferred through environmental seals of cable connector 204. As seal 252 is compliant, excessive force, particularly force above a threshold transferred from the protector housing in response to a force transverse to the engagement direction may distort the seal such that it does not provide suitable environmental containment and/or enables protector to move relative to bulkhead 120 such that the connectors inside do not remain reliably mated. These effects may, in some instances, impact performance of the interconnection system after the first instance of a force above the threshold being applied or performance impact may be seen after multiple instances of impulsive forces above the threshold. The threshold, for example, may be above 80 N, 100N, 120N, 140N or 160 N, according to some examples.

Also shown in the illustrated embodiment, portions 212a and 212b may be configured as lip portions proximate engagement interface 290. Portions 212a and 212b may be shorter in a direction perpendicular to the engagement direction 207 than the body of protector housing 210 from which portions 212a and 212b protrude. For example, as shown in FIG. 5, portions 212a and 212b have widths W1, which are less than width W2 separating walls of protector housing 210 on first side 228a and second side 228b. In the illustrated embodiment, width W1 is narrower than width W2, and widths W1 and W2 are in a direction perpendicular to engagement direction 207. While portions 212a and 212b are shown having the same width W1, in some embodiments portions 212a and 212b may have different widths. For example, portion 212a may have width W1 and portion 212b may have width 212b. As another example, portion 212b may have a width different from widths W1 and W2.

In some embodiments, protector housing 210 may have a substantially rectangular portion that is wider than portions 212a and 212b. For example, as shown in FIG. 5, walls of protector housing 210 spaced by width W2 are part of a substantially rectangular portion of protector housing 210. In the illustrated embodiment, the walls of protector housing include projections 214a and 214b configured for rotatably coupling to arms 232a and 232b of latch 230, respectively.

In some embodiments, exterior surfaces of portions 212a and 212b may be oriented transversely with respect to the widths W1 of portions 212a and 212b to engage interior surfaces of an electronic component. For example, as shown in FIG. 5, surface 226a of portion 212a is oriented toward first side 228 of protector housing 210 and normal to the direction of width W1 and surface 226b of portion 212b is oriented toward second side 228b of protector housing 210 and normal to the direction of width W1, with surfaces 226a and 226b spaced from one another by width W1.

While protector housing 210 is shown in FIGS. 1-5 including multiple portions 212a and 212b, in some embodiments, protector housing 210 may include only one of portions 212a and 212b.

As shown in FIG. 5, protector housing 210 may include one or more features for locking latching components in a latched position. In this example, protector housing 210 has a slot 216 proximate first end 220a and first opening 222a, closer to first end 220a than to second end 220b and closer to opening 222a than to second opening 222b. In some embodiments, slider 242 may be configured to engage latch 216 to lock latch 230 in the latched position, as described below in connection with FIGS. 6-8.

FIG. 6 is a sectioned perspective view of a portion of protector 205 of FIG. 1 including a spring-loaded locking mechanism according to some embodiments. FIG. 7 is a perspective view of the latch 230 of the protector 205 of FIG. 1 with slider 242 removed to show the slider channel 238 in which slider 242 is disposed.

In some embodiments, protector 205 may be configured to automatically lock protector housing 210 to bulkhead 120 when latch 230 is in the latched position without express user action. For example, slider 242 may be configured to lock latch 230 in place, preventing rotation of latch 230 from the locked position to the unlocked position. In some embodiments, slider 242 may be biased to project out and engage a catch of protector housing 210, such as slot 216, when latch 230 is in the locked position. As shown in the example of FIG. 6, slider 242 is spring-loaded within a channel 238 of latch 230 using a spring 246, and slider 242 has a tab 244 that aligns with slot 216 of protector housing 210 when latch 230 is in the locked position. In the illustrated embodiment, slider 242 may move toward slot 216 due to force from spring 246 once tab 244 is aligned with slot 216 and permitted to enter slot 216 as a result of latch 230 reaching the locked position. In some embodiments, handle 236 may be configured to rest against the surface of protector housing 210 above slot 216 when latch 230 is in the latched and locked position, such as shown in FIG. 6.

Spring 246 may be compressible to disengage slider 242 from the catch to unlock latch 230 when in the locked position. For example, moving slider 242 against the force of spring 246 may compress spring 246, allowing tab 244 to retract from slot 216. In this state, latch 230 may be rotated out of the locked position once tab 244 is retracted from slot 216. Biasing slider 242 to lock latch 230 in the locked position makes it easy for a user to secure protector 205 to an electronic component or to unlock latch 230 to release protector 205 from the electronic component.

In some embodiments, slider 242 may be slidably coupled to channel 238 of latch 230. For example, as shown in FIG. 7, slider channel 238 includes tracks permitting movement of slider 242 within slider channel 238 in a sliding direction, which in this example is parallel to the engagement direction 207. This configuration positions the slider for easy access by a user during movement of the protector 205 in a direction opposite engagement direction 207 (e.g. during disengagement). In However, as the sliding direction may change when the latch is rotated, when latch 230 is rotated out of the locked position, the sliding and mating directions may be transverse to one another. In some embodiments, tracks in slider channel 238 may restrict movement of slider 242 in directions transverse to the sliding direction.

As shown in FIG. 7, channel 238 is between the rotational coupling members (e.g., hubs) of latch 230 and handle 236. In some embodiments, slider 242 may be biased to project substantially in a direction from the rotational coupling members toward handle 236 to engage slot 216. For example, when latch 230 is in the locked position, as shown in FIG. 6, the sliding direction of slider 242 within channel 238 aligns tab 244 with slot 216.

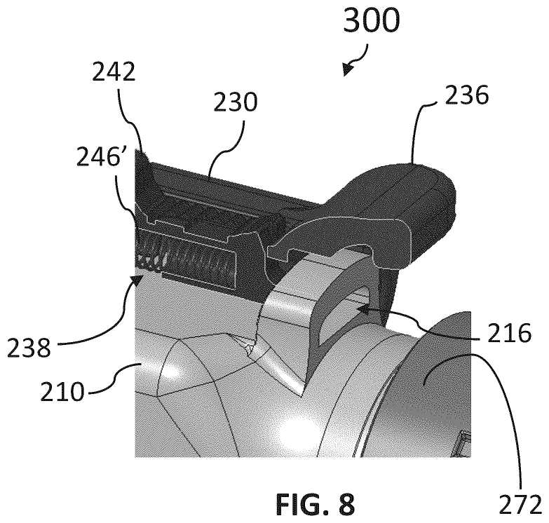

Spring 246 may be a coiled spring. Alternatively or additionally, spring 246 may be formed from compressible, insulative material, such as silicone or other elastomer that stores mechanical force when compressed. The inventors recognized and appreciated that, at least partially insulative springs such as elastomer springs reduce the amount of conductive material in the protector, reducing the susceptibility of the interconnection system to large voltages, such as may result from lightning strikes. It should be appreciated, however, that springs used in protector 205 may include at least some conductive material and/or may be made of metal, depending on the particular application. For example, an alternative spring with conductive material is described below in connection with FIG. 8.

In some embodiments, protector 205 may be configured to support spring 246 within a channel. For example, as shown in FIG. 6, protector 205 includes a spring channel 248 holding spring 246 between latch 230 and slider 242. In the illustrated embodiment, spring channel 248 is distributed between a first channel portion in latch 230 and a second channel portion in slider 242. In some embodiments, spring channel 248 may be configured to allow expansion of spring 246. For example, as shown in FIG. 6, spring channel 248 has a clearance area on the side adjacent protector housing 210 to allow expansion of spring 246 in directions perpendicular to the direction in which spring 246 is compressed. In the illustrated embodiment, clearance provided in spring channel 248 may allow expansion of spring 246 toward protector housing 210. Such a channel may be used in which spring 246 is made of a material, such as many elastomers, for which the volume changes little upon compression, and compression in one direction is achieved by displacing material of the spring in a different direction.

FIG. 8 is a sectioned perspective view of a cross-section of a portion of the cable connector 204 including a coil spring 246′ according to some alternative embodiments. In some embodiments, coil spring 246′ may be used in place of am elastomer spring 246.

In some embodiments, coil spring 246′ may include metal wound into a coil. It should be appreciated that other configurations of conductive springs are possible, such as leaf springs, depending on the particular application.

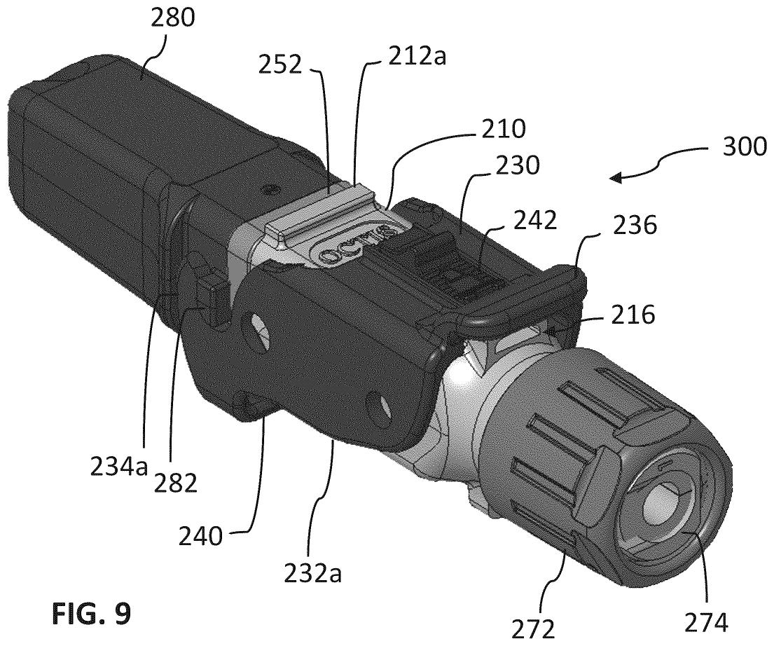

FIG. 9 is a perspective view of protector 205 of FIG. 1 with an end cap 280, in accordance with some embodiments. In some embodiments, end cap 280 may be configured to engage protector 205 to seal cable connector 204 inside protector 205 from external elements when cable connector 204 is not engaged with an electronic component. Cap 280 may have an engagement interface with some or all of the features of the engagement interface 290 on bulkhead 120. For example, as shown in FIG. 9, end cap 280 includes projections, of which projection 282 is labeled in FIG. 9. In the illustrated embodiment, latch 230 of protector 205 may be configured to engage the projections of end cap 280 to pull end cap 280 toward protector housing 210 with seal 252 at least partially compressed between end cap 280 and protector housing 210.

A protector for a cable connector may alternatively or additionally have other locking mechanisms to lock a latch in locked position in which the latch is engaged to a complementary component, such as bulkhead 120. In the example of FIG. 10, a portion of the cable interface 1070 may also serve as a locking mechanism. In the example illustrated, a nut that secures a cable to the protector housing may also serve as a locking mechanism. Nut 1072 may also engage a portion of the latch to secure the latch in the locked position, such as described below in connection with FIGS. 10-12.

FIG. 10 is a perspective view of a cable termination assembly 1004 that may be used in the electrical interconnection system 10 of FIG. 1, with a locking mechanism according to some alternative embodiments and an exemplary protective cap installed.

In some embodiments, cable termination assembly 1004 may be configured in the manner described herein for cable termination assembly 300. For example, as shown in FIG. 10, cable termination assembly 1004 includes a protector 1005 with protector housing 1010, latch 1030, seal 1052, and cable interface 1070, which may be configured in the manner described herein for protector housing 210, latch 230, seal 252, and cable interface 270. For example, as shown in FIG. 10, latch 1030 includes member 1040 and cable interface 1070 includes a nut 1072 securing a cone 1074 to protector housing 1010.

In some embodiments, protector 1005 may be engaged with an end cap in the manner described herein for protector 205. For example, as shown in FIG. 10, protector 1005 is engaged to an end cap 1080 with hook 1034a of latch 1030 engaged to a projection 1082 of end cap 1080.

In some embodiments, protector housing 1010 may have a portion configured to capture seal 1052 between protector housing 1010 and an electronic component (e.g., bulkhead 120). Protector housing 1010 may also include stabilizing components. For example, as shown in FIG. 10, protector housing 1010 has a portion 1012a protruding proximate an engagement interface of protector 1005. In the illustrated embodiment, portion 1012a has substantially the same width as the width spacing apart walls of protector housing 1010. Although not shown in FIG. 10, protector housing 1010 may further include a second portion protruding in a direction opposite that of portion 1012a and having substantially the same width as portion 1012a or a different width.

In some embodiments, nut 1072 may be configured to engage latch 1030 to lock latch 1030 in the locked position when nut 1072 is tightened onto protector housing. For example, as shown in FIG. 10, latch 1030 includes a tongue 1042 extending toward nut 1072. In some embodiments, nut 1072 may be configured to secure a cable (e.g., cable 202) to protector housing 1010 at a cable interface of housing 1010 and, while securing the cable to protector housing 1010 when latch 1030 is in the locked position, engage tongue 1042 to secure latch 1030 in the locked position.

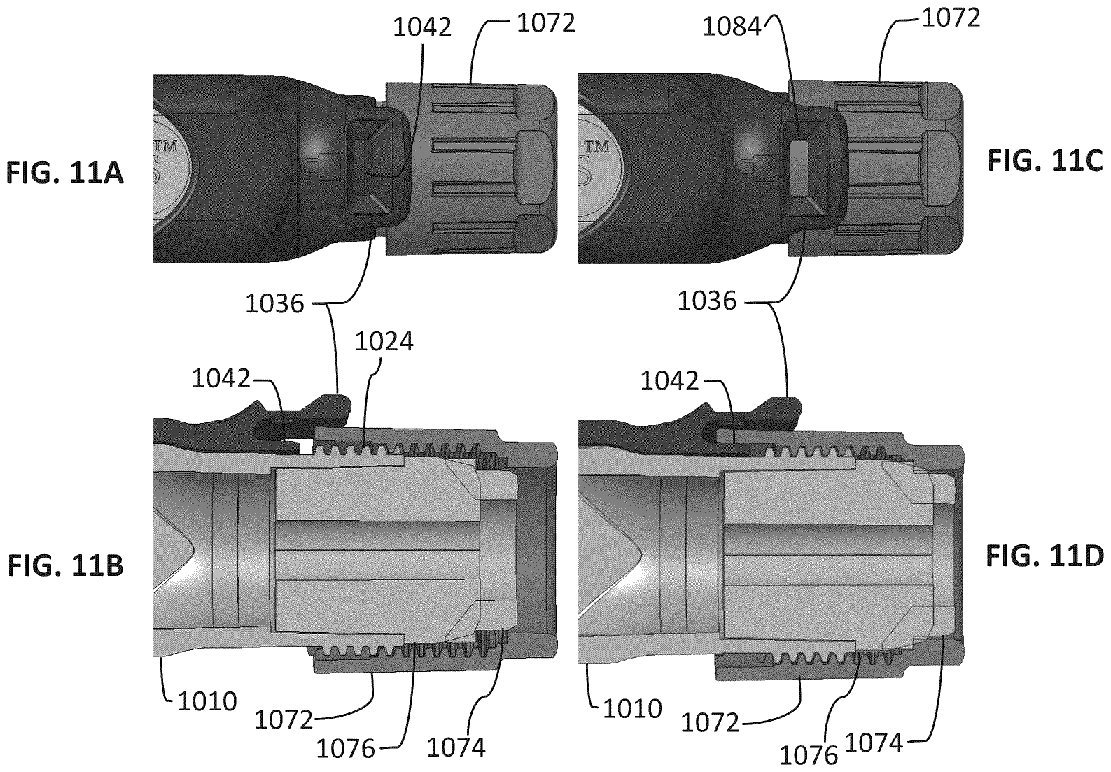

FIG. 11A is a top view of a portion of the protector 1005 of FIG. 10 showing the locking mechanism in a state with the nut 1072 unfastened. FIG. 11B is a side, cross-section of the cable connector 1004 of FIG. 10 with the nut 1072 unfastened in the state shown in FIG. 11A. In some embodiments, nut 1072 may be configured to provide clearance for latch 1030 to be rotated to the locked position when nut 1072 is unfastened, such as shown in FIGS. 11A-11B. As shown in FIG. 11B, latch 1030 has a gap between tongue 1042 and handle 1036 for receiving nut 1072 when nut 1072 is engaged, but not fully tightened, on threads 1024 of protector housing 1010. Subsequently, nut 1072 may be tightened onto threads 1024 to tighten cone 1074 and gland 1076 around a cable (not shown in FIGS. 11A-11D) threaded through nut 1072.

FIG. 11C is a top view of the cable connector 1004 of FIG. 10 with the nut 1072 fastened. FIG. 11D is a side, cross-section of the cable connector 1004 of FIG. 10 with the nut 1072 fastened as shown in FIG. 11C.

In some embodiments, nut 1072 may be configured to engage tongue 1042 of latch 1030 to block rotation of latch 1030 out of the locked position when nut 1072 is secured to protector housing 1010. For example, as shown in FIGS. 11C-11D, a portion of nut 1072 is in the gap between tongue 1042 and handle 1036 such that nut 1072 interferes with rotation of latch 1030 about the latch rotation axis (e.g., latch rotation axis 206) out of the locked position. In the illustrated embodiment, handle 1036 has a window 1084 allowing visual inspection of whether nut 1072 has engaged tongue 1042. In this example, nut 1072 and tongue 1042 may be different colors such that the color visible through window 1084 indicates whether nut 1072 has been tightened to secure tongue 1042.

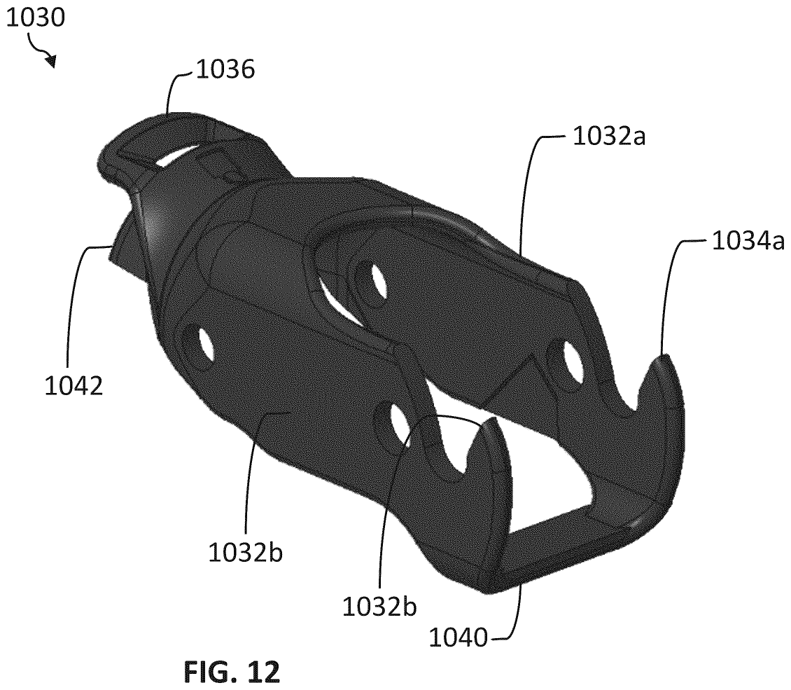

FIG. 12 is a perspective view of the latch 1030 of the cable connector 1004 of FIG. 10. In some embodiments, latch 1030 may be configured in the manner described herein for latch 230. For example, as shown in FIG. 12, latch 1030 includes arms 1032a and 1032b configured for rotatably coupling to projections of protector housing 1010 and terminating in hooks 1034a and 1034b. Also shown in FIG. 12, latch 1030 includes a handle 1036 connecting arms 1032a and 1032b on a first side (e.g., side 228c) and member 1040 connecting arms 1032a and 1032b on a second, opposite side (e.g., side 228d).

In some examples, a cable assembly with a protector as described herein may be connected to an electronic component according to a process in which failure to tighten nut 1072 might be readily detected, such that locking the latch via the nut may make it highly likely that the latch is locked in the latched position, without express steps to lock the latch. For example, a cable termination assembly may be prepared by threading gland 1076 and cone 1074 over the cable and then inserting the end of the cable into the protector. That end of the cable may be terminated to a cable connector, which may at least partially be disposed within the protector.

These operations may be performed in the field, where the cable termination assembly is coupled to an electronic component, or may be performed in advance. Nut 1072 may be partially tightened such as is shown in FIGS. 11A and 11B or may be fully disengaged from the threads of the protector housing.

In this state, the cable may slide relative to the protector housing. Such a configuration may enable the connector to be pulled out of the protector housing to simplify mating the cable connector to a connector within an electronic component. Once the connectors are mated, the protector housing may be slid along the cable to engage a bulkhead of the electronic component. In this state, nut 1072 may be tightened, which both secures the protector to the cable and locks the latch in the latched position.

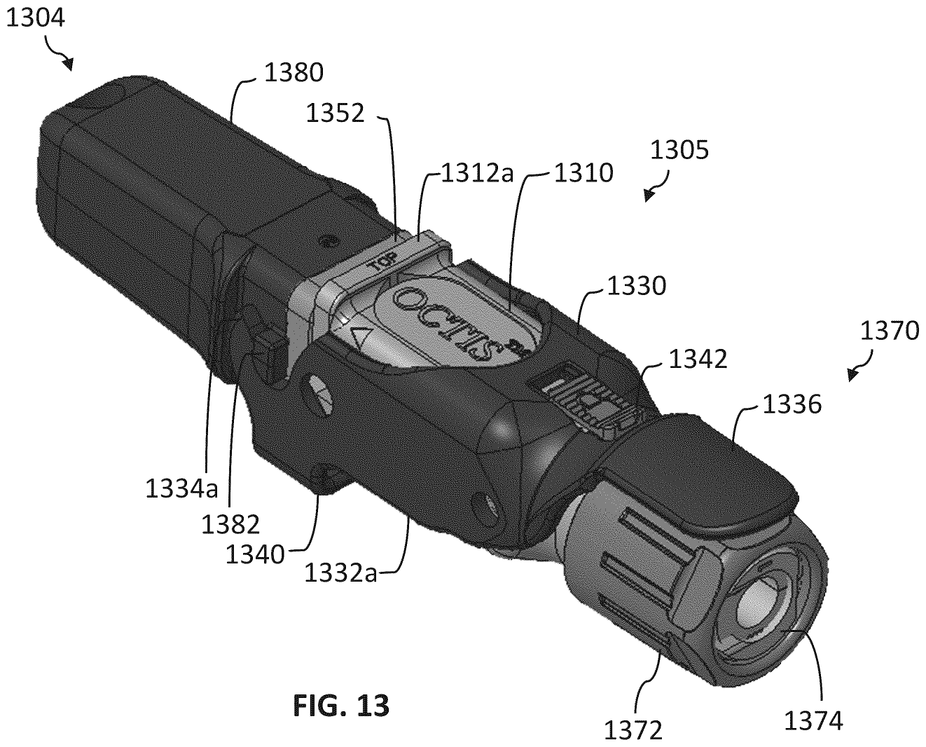

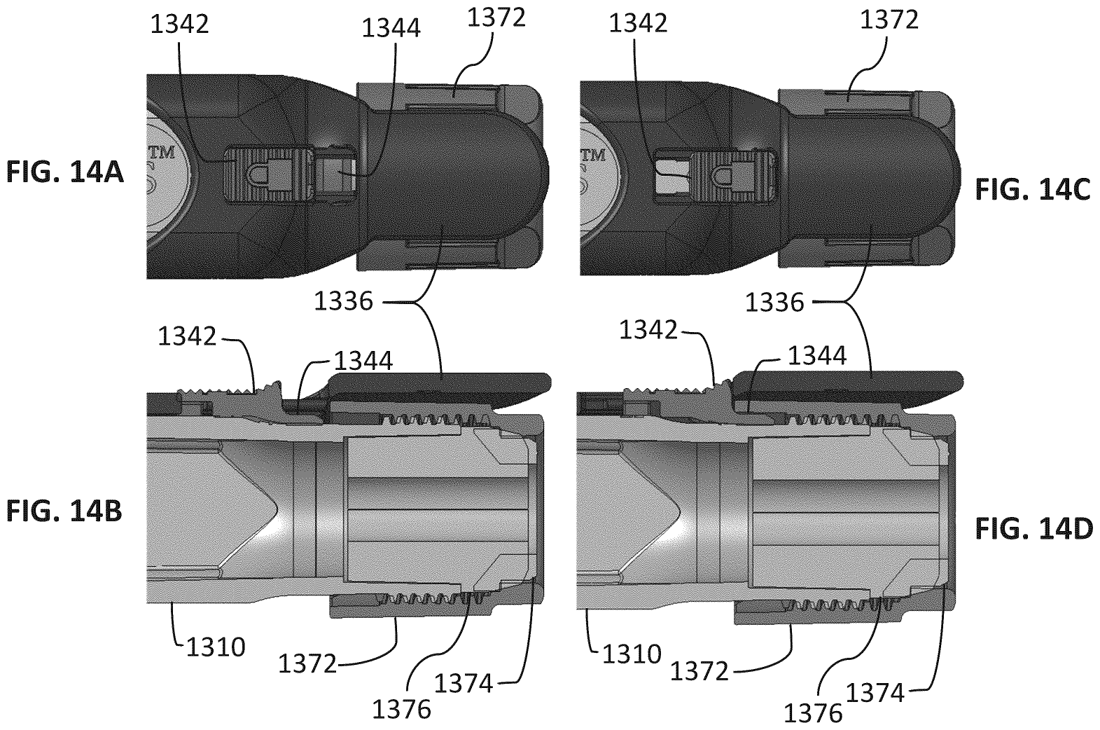

While automatic latch-locking mechanisms have been described, it should be appreciated that manual latch locking mechanisms may be used in some embodiments, such as described below in connection with FIGS. 13-14D.

FIG. 13 is a perspective view of a cable termination assembly 1304 that may be included in the electrical interconnection system 10 of FIG. 1, with a locking mechanism according to further alternative embodiments. In this example, a cable termination nut is used as part of the locking mechanism, but the locking mechanism may be activated after the nut is tightened.

In some embodiments, cable termination assembly 1304 may be configured in the manner described herein for cable termination assembly 300. For example, as shown in FIG. 13, cable termination assembly 1304 includes a protector 1305 with latch 1330, seal 1352, and cable interface 1370, which may be configured in the manner described herein for latch 230, seal 252, and cable interface 270. For instance, in the illustrated embodiment, latch 1330 includes arm 1332a terminating in hook 1332a and further includes handle 1336 and member 1340 connecting arm 1332a to the other arm (not shown) of latch 1330. Also shown in the illustrated embodiment, latch 1330 supports a slider 1342. In some embodiments, slider 1342 may be freely slidable with respect to latch 1330 to engage a catch on or coupled to the housing of protector 1305. In this example, that catch is formed by nut 1372 such that engagement of slider 1342 to nut 1372 locks latch 1330 in the latched position. For example, latch 1330 may include a slider channel with tracks allowing slider 1342 to slide relative to latch 1330.

In some embodiments, cable termination assembly 1304 may be engaged with an end cap in the manner described herein for cable termination assembly 300. For example, as shown in FIG. 13, cable connector 1304 is engaged to an end cap 1380 with hook 1334a of latch 1330 engaged to a projection 1382 of end cap 1380.

In some embodiments, cable termination assembly 1304 may be configured in the manner described herein for cable termination assembly 1004. For example, as shown in FIG. 13, protector 1305 further includes protector housing 1310 with portion 1312a having substantially the same width as the width spacing apart walls of protector housing 1310, such as described herein for protector housing 1010. Although not shown in FIG. 13, protector housing 1310 may further include a second portion protruding in a direction opposite that of portion 1312a and having substantially the same width as portion 1312a or a different width.

FIG. 14A is a top view of a portion of the cable termination assembly 1304 of FIG. 13 showing the locking mechanism in a state with the slider 1342 disengaged. FIG. 14B is a side, cross-section of the cable termination assembly 1304 of FIG. 13 with the slider 1342 disengaged as shown in FIG. 14A.

In some embodiments, when latch 1330 is in the locked position, slider 1342 may be configured to engage nut 1372 to secure latch 1330 in the locked position. For example, as shown in FIGS. 14A-14B, nut 1072 is fastened to protector housing 1310 pressing cone 1374 and gland 1376 against a cable (not shown). In the illustrated embodiment, slider 1342 has a tab 1344 that may be aligned with the gap when latch 1330 is rotated to the locked position and inserted into the gap when slider 1342 moves toward handle 1336.

FIG. 14C is a top view of the cable connector 1304 of FIG. 13 with the slider 1342 engaged. FIG. 14D is a side, view cross-section of the cable connector 1304 of FIG. 13 with the slider 1342 engaged as shown in FIG. 14C.

In some embodiments, slider 1342 may be configured to engage nut 1372 to prevent rotation of latch 1330 out of the latched position. For example, as shown in FIGS. 14C-14D, tab 1344 of slider 1342 is in the gap between nut 1372 and protector housing 1310 such that nut 1372 interferes with rotation of latch 1330 about the latch rotation axis (e.g., latch rotation axis 206) out of the locked position. In the illustrated embodiment, slider 1342 is not biased, and thus may be freely moved away from handle 1336 to remove tab 1344 from the gap between nut 1372 and protector housing 1310, permitting rotation of latch 1330 out of the locked position.

Although slider 1342 is shown configured to engage nut 1372, in some embodiments slider 1342 may be configured to engage a slot in protector housing 1310, such as described herein for protector 205 and slot 216. For example, slider 1342 may be freely movable with respect to latch 1330 to engage the slot and disengage the slot.

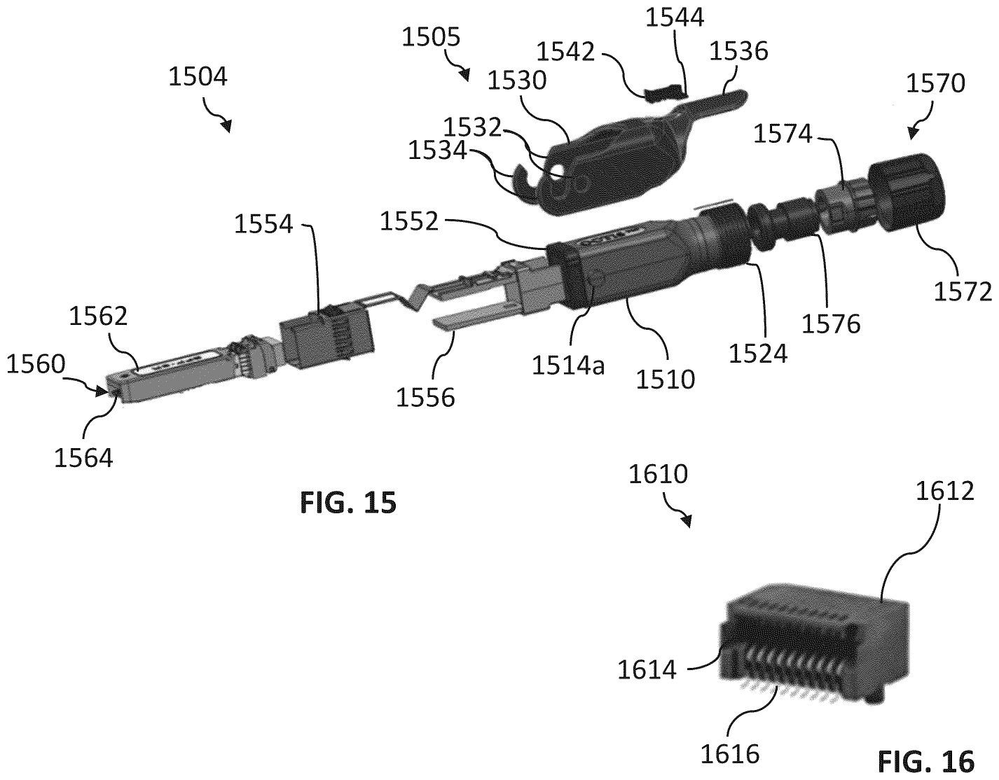

Protectors as described herein may be used for cable connectors and board connectors other than in the foregoing examples. FIG. 15, for example, is an exploded view of a cable connector 1504 that may be included in the electrical interconnection system 10 of FIG. 1. In this example, the cable connector includes optoelectronic component, such as a transceiver.

Other portions of the cable termination assembly 1504 may be configured in the manner described herein for cable termination assembly 300. For example, as shown in FIG. 15, cable termination assembly 1504 includes a protector including protector housing 1510, latch 1530, and cable interface 1570. In the illustrated embodiment, protector housing 1510 includes projections, such as projection 1514a, to which arms 1532 of latch 1530 are configured to rotationally couple. Also shown in the illustrated embodiment, latch 1530 has hooks 1532 that may be configured to engage projections of an electronic component (e.g., bulkhead 120). Also shown in the illustrated embodiment, latch 1530 supports a slider 1542 with a tab 1544, which may be configured in the manner described herein for slider 1342. Also shown in the illustrated embodiment, cable interface 1570 includes nut 1572, cone 1574, and gland 1576, which may be configured in the manner described herein for nut 272, cone 274, and gland 276. Also shown in the illustrated embodiment, cable termination assembly 1504 includes a seal 1552, an EMI shield 1554, and wings 1516 to couple the shield to a cable, which may be configured in the manner described for seal 252, cage 254, and wings 256, respectively.

In some embodiments, cable termination assembly 1504 may be configured to receive an optical cable. For example, as shown in FIG. 15, transceiver 1562 serves as a cable connector. Transceiver 1562 includes mating interface 1560 formed on a paddle card 1564. In some embodiments, transceiver 1562 may have a conductive housing to provide shielding for circuitry on paddle card 1564. For example, transceiver 1562 may be an optoelectronic transceiver having an optical modulator and/or demodulator configured to connect optical fibers of an optical cable to electrical traces on paddle card 1564.

While not shown in FIG. 15, it should be appreciated that aspects of cable termination assemblies 300, 1004, and/or 1304 may be implemented as part of cable termination assembly 1504. For example, protector housing 1510 may include one or more portions configured in the manner described herein for portions 212a and/or 212b. Alternatively or additionally, protector housing 1510 may include one or more portions configured in the manner described herein for portion 1012a. Alternatively or additionally, protector housing 1510 may include a slot configured in the manner described herein for slot 216. Alternatively or additionally, latch 1530 may include a member configured in the manner described herein for member 240. Alternatively or additionally, latch 1530 may include a biased slider configured in the manner described herein for slider 242. Alternatively or additionally, latch 1530 may include a tongue configured in the manner described herein for tongue 1042.

It should also be appreciated that, in some embodiments, cable termination assembly 1504 may alternatively enclose a connector with an optical mating interface.

FIG. 16 is a perspective view of a board connector 1610 that may be configured to mate with transceiver 1562 of FIG. 15, in accordance with some embodiments.

In some embodiments, board connector 1610 may be integrated within an electronic component in an interconnection system, such as mounted on a substrate (e.g., substrate 102) and aligned with a bulkhead 120 such that transceiver 1562 may be inserted through an opening in the bulkhead to mate with connector 1610. As shown in FIG. 16, board connector includes board housing 1612 with a slot 1614 configured to receive paddle card 1564 of cable connector 1504. In some embodiments, housing 1612 may be formed using insulative material such as plastic. Also shown in FIG. 16, board connector 1610 includes contacts 1616, which may be configured for solder mounting to a substrate. In the illustrated embodiment, contacts 1616 are exposed in slot 1614 to engage traces on paddle card 1564 when paddle card 1564 is inserted into slot 1614.

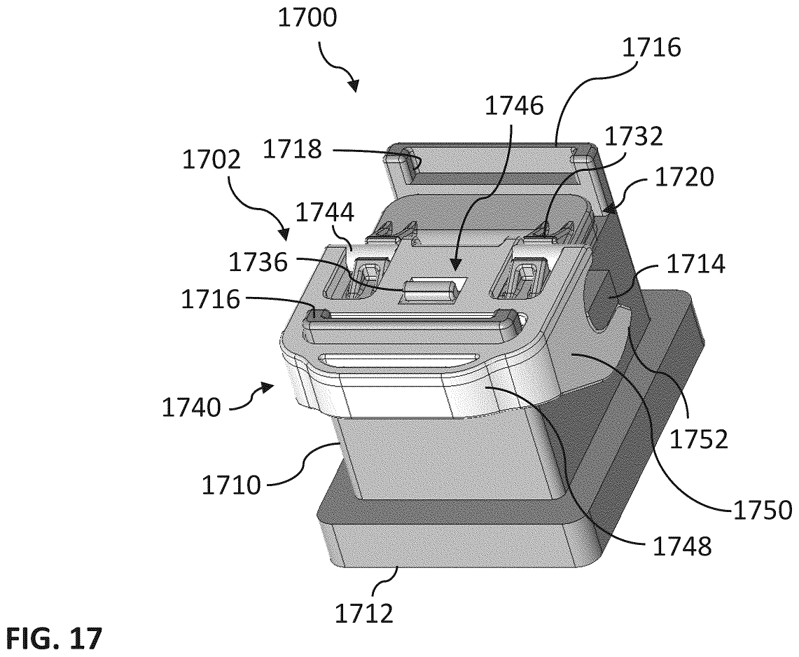

An interconnection system may include a protective cap for a bulkhead. Such a cap may provide environmental sealing for an electronic component including a bulkhead while the opening is not sealed by a protector as described herein. Alternatively or additionally, such a cap may suppress EMI emanating from or impinging on the electronic component as a result of radiation passing through an opening in the bulkhead. FIG. 17 is a perspective view of a portion of an electronic component with a bulkhead 1700. An exemplary cap 1702 in accordance with some embodiments is shown sealing an opening through bulkhead 1700. In this example, cap 1702 is latched to the features of bulkhead 1700 to which a protector 205 may be latched.

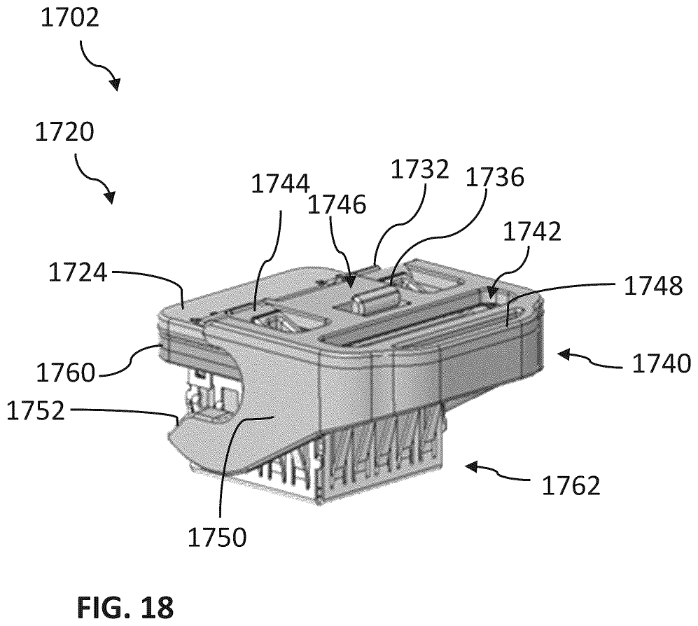

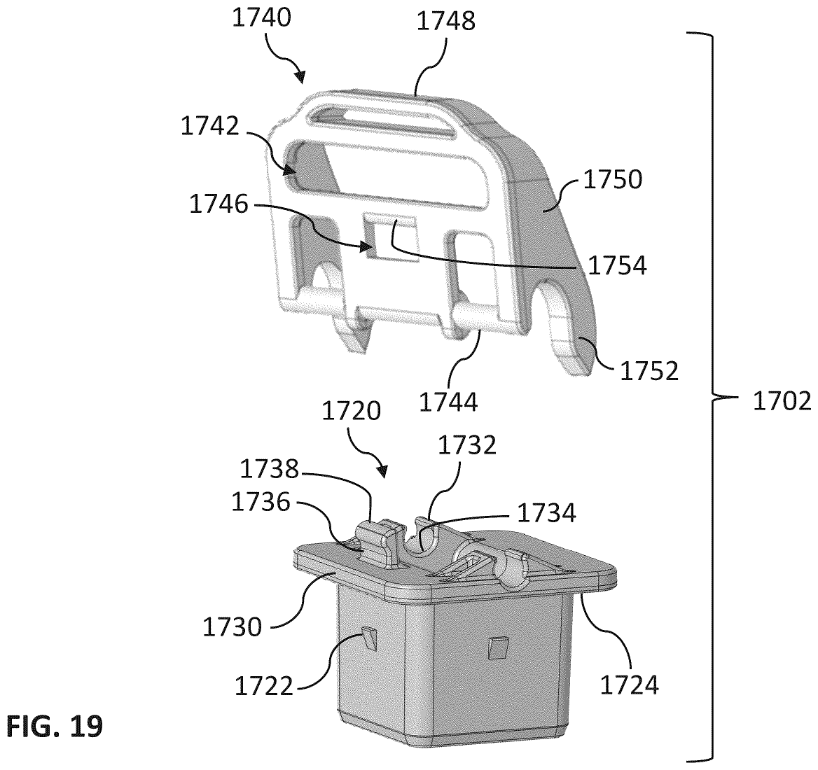

FIG. 18 is a perspective view of the cap 1702 of FIG. 17. FIG. 19 is an exploded view of the cap 1702 of FIG. 17 with seal 1760 and shield member 1762 removed.

In some embodiments, bulkhead 1700 may be part of an interconnection system, such as interconnection system 10. For example, bulkhead 1700 may be attached to or integrally formed with an enclosure for electronic assembly 100, such as an enclosure protecting board connector 110 from external elements.

In some embodiments, bulkhead 1700 may be configured in the manner described herein for bulkhead 120. For example, as shown in FIG. 17, bulkhead 1700 includes engagement projections 1712 and grooves 1716, which may be configured in the manner described herein for projections 126 and grooves 132 of bulkhead 120. In the illustrated embodiment, bulkhead 1700 includes a body 1710 with cavity walls 1714 protruding proximate a cavity (e.g., cavity 130), with grooves 1716 disposed in cavity walls 1714. While not shown in FIG. 17, bulkhead 1700 may further include fixing holes (e.g., fixing holes 124) for securing bulkhead 1700 to a panel of an enclosure.

In some embodiments, cap 1702 may include portion configured for inserting into a cavity of bulkhead 1700. For example, as shown in FIGS. 18-19, cap 1702 includes an insert 1720, shown in FIG. 17 inserted into bulkhead 1700. In some embodiments, insert 1720 may be configured to seal a cavity of bulkhead 1700. For example, as shown in FIGS. 18-19, a seal 1760 is attached to insert 1720, and insert 1720 further includes a plate 1724 configured to compress the seal 1760 against bulkhead 1700 when insert 1720 is within flange 1710. In the illustrated embodiment, plate 1724 and seal 1760 have larger cross sections than the portions inserted into the cavity of bulkhead 1700 in FIG. 17, where the cross section is in the plane normal to the direction of insertion.

In some embodiments, insert 1720 may be configured to limit EMI associated with radiation passing through bulkhead 1700. For example, insert 1720 may be made of conductive material, such as die cast metal, or may have conductive material plated or attached to exterior surfaces. For example, as shown in FIG. 18, a shield member 1762 is attached to exterior surfaces of insert 1720. In the illustrated embodiment, insert 1720 includes protrusions 1722 that fit within holes of a sheet of conductive material of shield member 1762 to retain the conductive material on exterior surfaces of insert 1720. In implementations in which shielding material bounds an exterior surface of cap 1702, such as shown in FIG. 18, cap 1702 optionally may be used in combination with other shielding material in the opening in bulkhead 1700 for improved suppression of EMI.

Cap 1702 may include features to hold insert 1720 in bulkhead 1700. In the example illustrated, retention may be provided through a latch, such as latch 1740. Latch 1740 may be rotatable with respect to insert 1720 to latch insert 1720 to bulkhead 1700 when insert 1720 is inserted into a cavity of bulkhead 1700. For example, as shown in FIGS. 17-19, latch 1740 has axles 1744 and plate 1724 of insert 1720 has snap fits 1730 into which axles 1744 may be inserted. The internal surfaces of snap fits 1730 are rounded to provide bearing surfaces for axles, 1744, enabling rotation of axle 1744 by providing a hinged attachment for latch 1740 to plate 1724. In the illustrated embodiment, such as shown in FIG. 19, snap fits 1730 includes channels 1732 spaced from one another along a rotation axis about which latch 1740 is configured to rotate with respect to insert 1720. In some embodiments, latch 1740 may be rotated to a position that latches insert 1720 to bulkhead 1700. For example, as shown in FIG. 17, latch 1710 includes arms 1750 terminating in hooks 1752 on opposing sides of latch 1740. In the illustrated embodiment, insert 1720 is inserted into the cavity of bulkhead 1700 bounded by cavity walls 1714 and latch 1740 is in the latched position. In the latched position, hooks 1752 are engaged to projections 1714 of bulkhead 1700 to latch insert 1720 to bulkhead 1700. In the illustrated embodiment, latching insert 1720 to bulkhead 1700 inhibits removal of insert 1720 from within the cavity of bulkhead 1700.

In some embodiments, latch 1740 may be rotatable from the locked position to an unlocked position in which insert 1720 may be inserted into or removed from a cavity of bulkhead 1700. For example, in the unlocked position, hooks 1752 may be disengaged from projections 1712 of bulkhead 1700, such as when latch 1740 is rotated 90 degrees with respect to insert 1720 from the locked position shown in FIG. 19. In the illustrated embodiment, latch 1740 includes handle 1748, which may be rotated to rotate latch 1740 and which may be pulled to remove insert 1720 from bulkhead 1700 when latch 1740 is in the unlatched position. It should be appreciated that other embodiments may have a larger or lesser degree of rotation than 90 degrees, such as 45 degrees, between latched and unlatched positions.

In some embodiments, latch 1740 may be configured to accommodate a protruding wall of bulkhead 1700 when rotated to a position in which latch 1740 latches insert 1720 to bulkhead 1700. For example, as shown in FIGS. 17-19, latch 1740 includes loop 1742, which may be sized and shaped to at least partially surround cavity wall 1714 of bulkhead 1700. In the illustrated embodiment, insert 1720 is inserted into the cavity of bulkhead 1700 and latch 1740 is rotated to the latched position, and cavity wall 1714 is disposed in and fully surrounded by loop 142. In some embodiments, loop 1742 may be further configured as a grip for disengaging insert 1720 from bulkhead 1700. For example, loop 1742 may be large enough to accommodate at least part of a person's finger or a pull tab to facilitate grasping latch 1740 for pulling insert 1720 out of bulkhead 1700. It should be appreciated that, in other embodiments, loop 142 may only partially surround cavity wall 1714. For example, loop 1742 may be open on the side where handle 1748 is shown.

Cap 1702 may include one or more features that hold latch 1740 in the latched position to reduce the chances that the cap will be unintentionally removed. In some embodiments, latch 1740 may be configured to snap fit with insert 1720 when latch 1740 is rotated to the latched position to lock latch 1740 in the latched position. For example, as shown in FIGS. 17-19, insert 1720 has a snap mechanism including a compliant member 1734, Similarly, as shown in FIGS. 17-19, latch 1740 includes a slot 1746. In some embodiments, slot 1746 may engage compliant member 1734 when latch 1740 is rotated with respect to insert 1720 toward the latched position. In the illustrated embodiment, compliant member 1734 has a rounded end protrusion 1736 and slot 1746 has a rounded edge 1754 proximate an interior wall. When latch 1740 is rotated towards the latched position, as shown in FIGS. 17-18, compliant member 1734 may glide over and beyond rounded edge 1754.

In this state, compliant member 1734 may be deflected, exerting a counter force on rounded edge 1754. The rounded end protrusion 1736 and rounded edge 1754 may be shaped to act as a cam such that the counter force urges latch 1740 towards plate 1724 where latch 1740 is in a latched state. This force may be sufficient to lock latch 1740 in a latched position. Alternatively or additionally, the counterforce may be sufficient to drive latch 1740 into plate 1724 with sufficient force to make a clicking or snapping sound, signaling to a user that the cap is firmly locked in place, increasing the likelihood that the cap will be firmly secured in use.

In the illustrated embodiment, interference between complaint member 1734 and slot 1746 causes inhibits undesired rotation of latch 1740. At the same time, a user may overcome the resistance provided by compliant member 1734 with sufficient force to deflect component member 1734 by manually rotating latch 1740 out of the latched position.

While latch 1740 is shown including two arms 1750 terminating in hooks 1752, in other embodiments latch 1740 may include only one arm 1750 terminating in one hook 1752, such as for applications in which a lesser degree of resistance to external elements is sufficient.

Having thus described at least one illustrative embodiment, various alterations, modifications and improvements will readily occur to those skilled in the art.

For example, a protector as described herein may include insulative housing and latching components, it should be appreciated that other embodiments may include conductive (e.g., metal) housing, latching or other components. While board connector 110 is shown in FIGS. 1 and 2A-2B as a right-angle connector, it should be appreciated that other interconnect configurations may be implemented. As one example, the board connector may be configured as a backplane connector with mating contacts extending away from the surface of the substrate 102.

While cable connector 204 is shown in FIGS. 1 and 2A-2B receiving a single cable 202, in some embodiments cable connector 204 may be configured to receive other cables in addition to cable 202. As one example, cable connector 204 may be configured to receive a bundle of cables (e.g., held in a sheath) including cables with power conductors, single-ended (e.g., coaxial) cables, and/or differential (e.g., twin-axial) cables.

While protector housing 210 is shown in FIGS. 1 and 2A-2B supporting an electrical mating interface 260, in other embodiments, protector housing 210 may be configured to support other types of mating interfaces in second opening 220b, such as for mating an optical cable with an electrical connector having an optoelectronic transceiver, as described further herein in connection with FIGS. 15-16.

As another example, protector housing 210 was illustrated as having a substantially rectangular cross section, but a protector housing may be made with other shapes, including with a circular or elliptical cross section.

Such alterations, modifications, and improvements are intended to be part of this disclosure and are intended to be within the spirit and scope of the invention. Further, though advantages of the present invention are indicated, it should be appreciated that not every embodiment of the invention will include every described advantage. Some embodiments may not implement any features described as advantageous herein and in some instances. Accordingly, the foregoing description and drawings are by way of example only.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified.

As used herein in the specification and in the claims, the phrase “equal” or “the same” in reference to two values (e.g., distances, widths, etc.) means that two values are the same within manufacturing tolerances. Thus, two values being equal, or the same, may mean that the two values are different from one another by ±5%.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

1.-23. (canceled)

24. An electrical interconnection system, comprising:
a protector for a connector comprising a first housing comprising a first engagement interface and a seal proximate the first engagement interface; and
an electronic component comprising a second housing supporting a second engagement interface and comprising a cavity proximate the second engagement interface,
wherein the first housing and the second housing are configured to at least partially compress the seal therebetween and to limit movement of the second housing with respect to the first housing when the first housing engages the second housing.

25. The electrical interconnection system of claim 24, wherein:
the first and second engagement interfaces are configured to engage one another when moved together in an engagement direction; and
the first housing is configured to press against the second housing when the first housing is engaged to the second housing and moved in a plane normal to the engagement direction.

26. The electrical interconnection system of claim 25, wherein:
the first housing comprises exterior surfaces configured to engage respective interior surfaces of the second housing when the first housing is engaged to the second housing and moved in the plane normal to the engagement direction.

27. The electrical interconnection system of claim 26, wherein:
the first housing comprises a first portion extending beyond the seal in a second direction perpendicular to the engagement direction;
the first portion comprises the exterior surfaces; and
the second housing comprises a cavity and a groove proximate the cavity, the groove comprising the interior surfaces.

28. (canceled)

29. The electrical interconnection system of claim 25, wherein the first housing comprises:
a first lip protruding in a first direction perpendicular to the engagement direction; and
a second lip proximate the engagement interface and protruding in a second direction perpendicular to the engagement direction and different from the first direction, the first and second lips being configured to engage the second housing to limit movement of the housing in the plane normal to the engagement direction, and
wherein the second direction is opposite the first direction.

30. (canceled)

31. The electrical interconnection system of claim 29, wherein the first housing comprises:
a first portion having a first wall on a first side of the engagement interface and a second wall on a second side of the engagement interface, the first portion having a first width perpendicular to the engagement direction from the first wall to the second wall; and
the first lip comprises a portion having a second width perpendicular to the engagement direction that is narrower than the first width.

32. The electrical interconnection system of claim 31, wherein:
the portion of the first lip comprises:
a first surface normal to a direction of the first and second widths; and
a second surface normal to the direction of the first and second widths, the second surface spaced from the first surface by the second width; and
the first and second surfaces of the portion of the first lip are configured to engage respective interior surfaces of the second housing proximate the cavity when the first housing is engaged to the second housing and moved in the plane normal to the engagement direction.

33. The electrical interconnection system of claim 32, wherein:
the first surface of the portion of the first lip is configured to, when the first housing is engaged to the second housing and moved in a third direction in the plane normal to the engagement direction, press against a first interior surface of the second housing proximate the cavity; and
the second surface of the portion of the first lip is configured to, when the first housing is engaged to the second housing and moved in a fourth direction in the plane normal to the engagement direction and opposite the third direction, press against a second interior surface of the second housing proximate the cavity.

34. The electrical interconnection system of claim 29, wherein:
the first housing comprises a first body configured to at least partially compress the seal between the first body and the second housing when the first housing engages the second housing;
the first and second lips are configured to press against the second housing when the first housing is rotated about an axis perpendicular to the engagement direction and to the first direction; and
the first and second lips are further configured to enclose the seal between the first and second lips and the second housing when the first housing is rotated about the axis.

35. (canceled)

36. The electrical interconnection system of claim 34, wherein the second housing comprises:
a first portion configured to enclose the seal between the first lip and the first portion when the first housing is rotated about the axis away from the first portion; and
a second portion configured to enclose the seal between the second lip and the second portion when the first housing is rotated about the axis away from the second portion, and
wherein the first portion is spaced from the second portion in the first direction and the first and second portions protrude from the second housing in the engagement direction.

37.-38. (canceled)

39. The electrical interconnection system of claim 24, wherein:
the connector further comprises a latch that is rotatable with respect to the first housing to lock the connector to the electronic component, and
the latch is rotatable in a first rotational direction toward a locked position to pull the first housing toward the second housing and in a second rotational direction toward an unlocked position to unlock the first housing from the second housing.

40. (canceled)

41. The electrical interconnection system of claim 39, wherein the latch comprises:
a first arm rotatably coupled to a first side of the first housing and configured to engage a first side of the second housing;
a second arm rotatably coupled to a second side of the first housing and configured to engage a second side of the second housing; and
a stabilizer member configured to distribute force applied to one of the first arm and the second arm to the other of the first arm and the second arm to limit movement of the latch in a direction parallel to an axis of rotation of the latch.

42. A protector for a connector configured to engage an electronic component, the protector comprising:
a housing comprising:
a body configured to enclose, at least in part, a connector, the body comprising an opening oriented along a mating direction of the connector to expose a mating interface of the connector to enable the connector to mate with a mating connector of the electronic component; and
a first lip proximate the opening and configured to engage the electronic component to limit motion of the housing in a plane normal to the mating direction; and
a seal,
wherein the body is configured to compress the seal between the body and the electronic component when the housing is engaged to the electronic component.

43. The protector of claim 42, wherein the first lip comprises exterior surfaces configured to engage respective interior surfaces of the electronic component when the housing is engaged to the electronic component and moved in the plane normal to the mating direction.

44. The protector of claim 42, wherein:
the first lip protrudes from the body in a first direction perpendicular to the mating direction;
the housing further comprises a second lip proximate the opening and protruding from the housing in a second direction perpendicular to the mating direction and different from the first direction, the second lip being configured to engage the electronic component to limit rotation of the housing in the plane normal to the mating direction; and
the second direction is opposite the first direction.

45. (canceled)

46. The protector of claim 4, wherein the first and second lips are further configured to limit rotation of the housing about an axis perpendicular to the mating direction and to the first direction.

47. The protector of claim 46, wherein the first and second lips are further configured to enclose the seal between the first and second lips and the electronic component when the housing is rotated about the axis.

48. The protector of claim 42, wherein:
the housing comprises a first portion comprising the opening and having a first width perpendicular to the mating direction; and
the first lip comprises a portion having a second width perpendicular to the mating direction that is narrower than the first width.

49. The protector of claim 48, further comprising:
a latch that is rotatable with respect to the housing about a second axis to lock and unlock the housing to and from the electronic component,
wherein:
the first portion of the housing comprises a first wall and a second wall spaced from the first wall by the first width;
arms of the latch are rotatably coupled to the first and second walls, respectively; and
the latch comprises a stabilizer member configured to distribute force applied to one of the arms to the other of the arms to limit movement of the latch in a direction parallel to the second axis.

50. The protector of claim 48, wherein:
the portion of the first lip comprises:
a first surface normal to a direction of the first and second widths; and
a second surface normal to the direction of the first and second widths, the second surface spaced from the first surface by the second width; and
the first and second surfaces of the portion of the first lip are configured to engage respective interior surfaces of the electronic component when the housing is engaged to the electronic component and moved in the plane normal to the mating direction.

51. The protector of claim 50, wherein:
the first surface of the portion of the first lip is configured to, when the housing is engaged to the electronic component and moved in a third direction in the plane normal to the mating direction, press against a first interior surface of the electronic component; and
the second surface of the portion of the first lip is configured to, when the housing is engaged to the electronic component and moved in a fourth direction in the plane normal to the mating direction and opposite the third direction, press against a second interior surface of the electronic component.

52. The protector of claim 42, wherein the opening is positioned at a first end of the housing, and the housing further comprises a second opening configured to receive a cable at a second end of the housing.

53.-89. (canceled)
